(19) United States
(12) Patent Application Publication
(10) Pub. No.: US 2014/0086501 A1
(43) Pub. Date: Mar. 27, 2014

(54) IMAGE PROCESSING DEVICE AND IMAGE PROCESSING METHOD

(71) Applicants: Masaru Ikeda, Kanagawa (JP); Kazuya Ogawa, Tokyo (JP); Ohji Nakagami, Tokyo (JP)

(72) Inventors: Masaru Ikeda, Kanagawa (JP); Kazuya Ogawa, Tokyo (JP); Ohji Nakagami, Tokyo (JP)

(73) Assignee: SONY CORPORATION, Tokyo (JP)

(21) Appl. No.: 14/116,053

(22) PCT Filed: May 24, 2012
(86) PCT No.: PCT/JP2012/063280

§ 371 Date: Nov. 6, 2013

(30) Foreign Application Priority Data
Jun. 28, 2011 (JP) 2011-143460
Nov. 2, 2011 (JP) 2011-241014
Jan. 19, 2012 (JP) 2012-008966

(51) Int. Cl. H04N 7/26

(52) U.S. Cl. CPC H04N 19/00527; H04N 19/00303; H04N 19/00066; H04N 19/00157
USPC 382/233

(57) ABSTRACT

A filtering operation unit (254) performs a filtering operation by using the image data and the coefficient set of taps constructed with respect to a pixel to be filtered, the pixel to be filtered being of an image generated through a decoding process. A filter control unit (259) determines a tap position in a block. When the tap position is located within a predetermined range from a block boundary, the image data of taps located within the predetermined range is replaced or the coefficient set is changed so that the filtering operation can be performed without the use of image data within the predetermined range. Thus, the memory capacity of the line memory to be used in the loop filtering process can be reduced.

### TECHNICAL FIELD

This technique relates to image processing devices and image processing methods. Specifically, this technique is to reduce the memory capacity of the line memory to be used in a loop filtering process for an image that has been subjected to an encoding process and a decoding process on a coding unit basis.

### BACKGROUND ART

In recent years, to handle image information as digital information and achieve high-efficiency information transmission and accumulation in doing do, apparatuses compliant with a standard, such as MPEG2 (ISO (International Organization for Standardization)/IEC (International Electrotechnical Commission) 13818-2) for compressing image information through orthogonal transforms such as discrete cosine transforms and motion compensation by taking advantage of redundancy inherent to the image information, have been spreading among broadcast stations that distribute information and among general households that receive information. Also, methods called H.264 and MPEG4 Part 10 (AVC (Advanced Video Coding)) for achieving higher encoding efficiency are now used, though a larger amount of calculation is required for encoding and decoding by such methods, compared with MPEG2 and the like. Further, standardization of HEVC (High Efficiency Video Coding) as a next-generation image encoding method is now under way in JCTVC (Joint Collaboration Team—Video Coding), which is a joint standards organization of ITU-T and ISO/IEC, so as to realize efficient compression and distribution of high-resolution images of 4000×2000 pixels, which is four times as high as the resolution of a high-definition image.

By such an image encoding method for achieving high encoding efficiency, block distortions remaining after a deblocking filtering process and distortions caused by quantization are being reduced with the use of an adaptive loop filter (ALF) (Patent Document 1, Non-Patent Document 1).

Also, providing PQAO (Picture Quality Adaptive Offset) disclosed in Non-Patent Document 2 between a deblocking filter and an adaptive loop filter is being examined by HEVC. Offset types include two types called band offsets, and six types called edge offsets. Further, any offset may not be used. An image is divided in a quad-tree, and one or more of the above mentioned offset types can be selected for encoding in each of the regions, to increase encoding efficiency.

### CITATION LIST

### Patent Document

Patent Document 1: JP 2011-49740 A

### Non-Patent Documents

Non-Patent Document 1: Ken. McCann (Samsung/ZetaCast), Benjamin. Bross (HHI), Shun-ichi. Sekiguchi (Mitsubishi), Woo-Jin. Han (Samsung), “JCTVC-E602 HM3: High Efficiency Video Coding (HEVC) Test Model 3 Encoder Description”, Joint Collaborative Team on Video Coding (JCT-VC) of ITU-T SG16 WP3 and ISO/IEC JTC1/SC29/WG11, 5th Meeting: Geneva, CH, 16-23 Mar., 2011
Non-Patent Document 2: “CE8 Subtest 3: Picture Quality Adaptive Offset”, JCTVC-D122, January 2011

### SUMMARY OF THE INVENTION

### Problems to be Solved by the Invention

In the adaptive loop filter, taps are set for the current pixel being processed by the adaptive loop filter, and a filtering operation is performed by using the image data of the taps. The taps are included in the filtering range of the filter provided in the stage before the adaptive loop filter. That is, image data subjected to a filtering process by the filter provided in the stage before the adaptive loop filter is required in a loop filtering process. Therefore, an image processing device that performs loop filtering processes stores the image data of a predetermined number of lines from a boundary into a line memory so that an adaptive loop filtering process can be performed after a filtering process by the filter provided in the stage before the adaptive loop filter, when an image is processed in the raster scanning direction on a coding unit basis (a block basis).

As described above, in a case where taps are included in the filtering range of the filter provided in the stage before the adaptive loop filter, the image processing device needs to store the image data of a predetermined number of lines from the boundary so that an adaptive loop filtering process can be performed after a filtering process by the filter provided in the stage before the adaptive loop filter. Therefore, where the number of pixels in the horizontal direction is large, a line memory with a large memory capacity is required.

In view of this, this technique provides image processing devices and image processing methods that can reduce the memory capacity of the line memory to be used in the loop filtering process.

### Solutions to Problems

A first aspect of this technique is an image processing device that includes: a decoding unit that generates an image by decoding encoded data generated by encoding an image; a filtering operation unit that performs a filtering operation by using image data and a coefficient set of taps constructed with respect to a pixel to be filtered, the pixel to be filtered being of the image generated by the decoding unit; and a filter control unit that controls the filtering operation to be performed without the use of image data within a predetermined range from a boundary when a tap position is located within the predetermined range.

By this technique, the filtering operation is performed by using the image data and the coefficient set of the taps constructed with respect to the pixel to be filtered, the pixel to be filtered being of an image formed by decoding encoded data generated by encoding an image. In a case where tap positions are located within a predetermined range from a boundary or within the filtering range of a deblocking filtering process or a pixel range in which an SAO (Sample Adaptive Offset) process has not been performed, for example, the image data of the taps located within the predetermined range is replaced or the coefficient set is changed so that the filtering operation can be performed without the use of image data within the predetermined range, or the tap shape of the filter is changed so that the filtering operation can be performed without the use of image data within the predetermined range. In a case where the upper end or the lower end of the filter is located outside a boundary, the image data of taps located in a region including lines located outside the boundary is replaced or the coefficient set of the filter is changed, or the image data is replaced or the coefficient set is changed so that pixels adjacent to the outer periphery of the boundary of the predetermined range are copied in the vertical direction and are used as taps in the predetermined range, or the image data is replaced or the coefficient set is changed so that pixels having mirror copies thereof formed on taps located within the predetermined range are used, with the axis of the mirror copying being formed with the positions of pixels adjacent to the outer periphery of the boundary of the predetermined range. In the filtering operation, a coefficient set that is constructed based on coefficient set information included in the encoded image is used. The encoded data is encoded for each unit having a hierarchical structure, and the boundary is a boundary of a largest coding unit that is the largest unit among coding units. Alternatively, the encoded data is encoded for each unit having a hierarchical structure, and the boundary is a line boundary that is a boundary of a range including several lines counted from a boundary of a largest coding unit that is the largest unit among coding units.

A second aspect of this technique is an image processing method that includes: a step of generating an image by decoding encoded data generated by encoding an image; a step of performing a filtering operation by using image data and a coefficient set of taps constructed with respect to a pixel to be filtered, the pixel to be filtered being of the image generated by the decoding; and a step of controlling the filtering operation to be performed without the use of image data within a predetermined range from a boundary when some of the taps are located within the predetermined range.

A third aspect of this technique is an image processing device that includes: a filtering operation unit that performs a filtering operation by using the image data and the coefficient set of taps constructed with respect to a pixel to be filtered when an image is encoded, the pixel to be filtered being of the image subjected to local decoding; a filter control unit that controls the filtering operation to be performed without the use of image data within a predetermined range from a boundary when some of the taps are located within the predetermined range; and an encoding unit that encodes the image by using the image subjected to the filtering operation by the filtering operation unit.

By this technique, the filtering operation is performed by using the image data and the coefficient set of the taps constructed with respect to the pixel to be filtered when an image is encoded, the pixel to be filtered being of a locally decoded image. In a case where tap positions are located within a predetermined range from a boundary, the filtering operation is controlled so that the filtering operation is performed without the use of image data within the predetermined range, and image encoding is performed by using the image subjected to the filtering operation. In controlling the filtering operation, the image data of taps located within the predetermined range is replaced or the coefficient set is changed, or the tap shape of the filter is changed so that the filtering operation can be performed without the use of image data within the predetermined range. In a case where the upper end or the lower end of the filter is located outside a boundary, the image data of taps within a region including lines located outside the boundary is replaced, or the coefficient set is changed, for example.

A fourth aspect of this technique is an image processing method that includes: a step of performing a filtering operation by using the image data and the coefficient set of taps constructed with respect to a pixel to be filtered when an image is encoded, the pixel to be filtered being of the image subjected to local decoding; a step of controlling the filtering operation to be performed without the use of image data within a predetermined range from a boundary when some of the taps are located within the predetermined range; and a step of encoding the image by using the image subjected to the filtering operation.

### Effects of the Invention

According to this technique, a filtering operation is performed by using the image data and the coefficient set of taps constructed for the pixel being subjected to a filtering process for an image generated by decoding encoded data generated by encoding an image. When tap positions are located within a predetermined range from a boundary, the filtering operation is controlled to be performed without the use of image data within the predetermined range. Accordingly, an adaptive loop filtering process can be performed without the use of image data subjected to a deblocking filtering process, for example, and the memory capacity of the line memory to be used in the loop filtering process can be reduced.

### BRIEF DESCRIPTION OF DRAWINGS

FIG. 1 is a diagram for explaining image data stored in a line memory in a conventional loop filtering process.

FIG. 2 is a diagram showing a structure in a case where the present technique is applied to an image encoding device.

FIG. 3 is a flowchart showing an image encoding operation.

FIG. 4 is a flowchart showing an intra prediction process.

FIG. 5 is a flowchart showing an inter prediction process.

FIG. 6 is a diagram showing a structure in a case where the present technique is applied to an image decoding device.

FIG. 7 is a flowchart showing an image decoding operation.

FIG. 8 is a diagram showing the structure of a first embodiment of the loop filtering unit.

FIG. 9 is a flowchart showing an operation of the first embodiment of the loop filtering unit.

FIG. 10 is a diagram showing an example of a tap shape.

FIG. 11 is a diagram showing examples of tap constructions for the deblocking filtering process in the first embodiment.

FIG. 12 is a diagram showing examples of coefficient sets for the deblocking filtering process in the first embodiment.

FIG. 13 is a diagram showing the image data stored in the line memory in a case where taps or a coefficient set for the deblocking filtering process is constructed.

FIG. 14 is a diagram showing examples of tap constructions for the deblocking filtering process in a second embodiment.

FIG. 15 is a diagram showing examples of coefficient sets for the deblocking filtering process in the second embodiment.

FIG. 16 is a diagram showing the structure of a third embodiment of the loop filtering unit.

FIG. 17 is a flowchart showing an operation of the third embodiment of the loop filtering unit.

FIG. 18 shows a current pixel located in such a position that the loop filter is put into an off state.

FIG. 19 is a diagram for explaining conventional processes in cases where a virtual boundary is set.

FIG. 20 is a diagram showing an example of a filter shape.

FIG. 21 is a diagram for explaining processes in cases where one or more lower end lines are located outside a boundary.

FIG. 22 is a diagram for explaining processes in cases where one or more upper end lines are located outside a boundary.

FIG. 23 is a diagram for explaining processes to change filter size and filter shape in cases where one or more lower end lines are located outside a boundary.

FIG. 24 is a diagram for explaining processes to change filter size and filter shape in cases where one or more upper end lines are located outside a boundary.

FIG. 25 is a diagram showing another structure in a case where the present technique is applied to an image encoding device.

FIG. 26 is a diagram for explaining a quad-tree structure.

FIG. 27 is a diagram for explaining edge offsets.

FIG. 28 is a diagram showing lists of rules for edge offsets.

FIG. 29 shows a relationship in image data (luminance data) to be stored in the line memory.

FIG. 30 shows a relationship in image data (chrominance data) to be stored in the line memory.

FIG. 31 is a flowchart showing an operation of another structure in the case where the present technique is applied to an image encoding device.

FIG. 32 is a diagram showing another structure in a case where the present technique is applied to an image decoding device.

FIG. 33 is a flowchart showing an operation of another structure in the case where the present technique is applied to an image decoding device.

FIG. 34 is a flowchart showing a process in which the number of taps is reduced.

FIG. 35 is a diagram for explaining an operation (luminance data) of the loop filtering unit in a case where the number of taps is reduced.

FIG. 36 is a diagram for explaining an operation (chrominance data) of the loop filtering unit in a case where the number of taps is reduced.

FIG. 37 is a flowchart showing a process in which the loop filtering process is not performed on a certain line when the number of taps is reduced.

FIG. 38 is a diagram for explaining an operation (luminance data) of the loop filtering unit in a case where the loop filtering process is not to be performed on the last line among the lines subjected to the SAO process.

FIG. 39 is a diagram for explaining an operation (chrominance data) of the loop filtering unit in a case where the loop filtering process is not to be performed on the last line among the lines subjected to the SAO process.

FIG. 40 is a block diagram schematically showing an example structure of a television apparatus.

FIG. 41 is a block diagram schematically showing an example structure of a portable telephone device.

FIG. 42 is a block diagram schematically showing an example structure of a recording/reproducing apparatus.

FIG. 43 is a block diagram schematically showing an example structure of an imaging apparatus.

### MODES FOR CARRYING OUT THE INVENTION

The following is a description of embodiments for carrying out the present technique. Explanation will be made in the following order.

1. Conventional loop filtering process

2. Structure in which the present technique is applied to an image encoding device

3. Operation of the image encoding device

4. Structure in which the present technique is applied to an image decoding device

5. Operation of the image decoding device

6. Fundamental structure and operation of the loop filtering unit

7. First embodiment of the loop filtering unit

8. Second embodiment of the loop filtering unit

9. Third embodiment of the loop filtering unit

10. Fourth embodiment of the loop filtering unit

11. Fifth embodiment of the loop filtering unit

12. Another structure and operation in a case where the present technique is applied to an image encoding device

13. Another structure and operation in a case where the present technique is applied to an image decoding device

14. Sixth embodiment of the loop filtering unit

15. Applications

### <1. Conventional Loop Filtering Process>

In a case where an image is processed in a raster scanning direction on a coding unit basis (a block basis), vertical filtering in a filtering process by a filter (such as a deblocking filter) provided in a stage before a loop filter is performed by using the image data of a block (a current block) to perform a loop filtering process and the block located immediately below the current block. Also, the loop filtering process is performed by using the image data subjected to the deblocking filtering process. Therefore, the image data of a predetermined number of lines of the current block is stored in a line memory so that the loop filtering process can be performed by using the image data subjected to the deblocking filtering process. Also, the loop filtering process is performed by using stored image data and image data subjected to the deblocking filtering process performed with the use of the image data of the block located immediately below the current block.

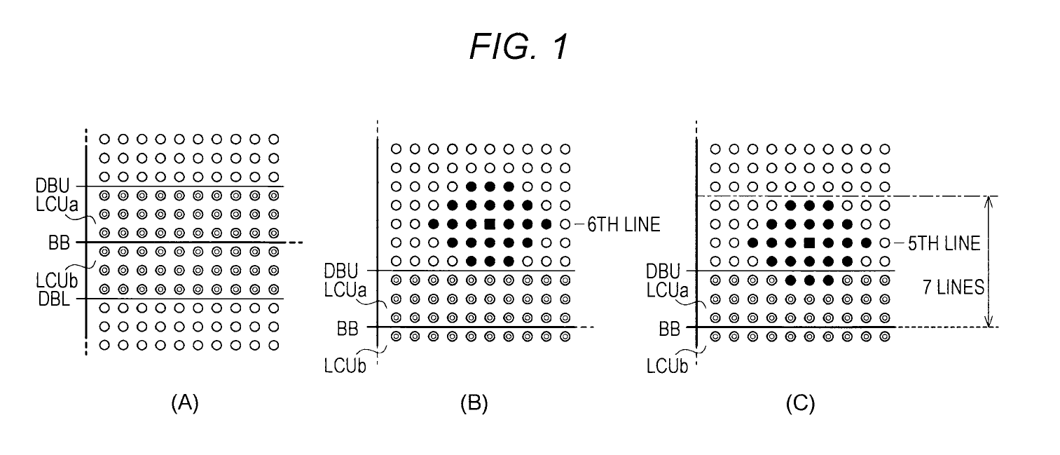

FIG. 1 is a diagram for explaining image data stored in the line memory in a conventional loop filtering process. In the vertical filtering in a deblocking filtering process, image data that is of the three lines counted from a block boundary and has been subjected to the deblocking filtering process is generated for each column by using the image data of the four lines counted from the block boundary, for example, as shown in (A) of FIG. 1. The pixels subjected to the deblocking filtering process are indicated by double circles. The block boundary between blocks such as each LCUa (Largest Coding Unit a) and each LCUb is represented by “BB”, the upper boundary of the filtering range of the deblocking filter is represented by “DBU”, and the lower boundary is represented by “DBL”.

In the adaptive loop filter, as shown in (B) and (C) of FIG. 1, taps are set for the current pixel (represented by a black square) to be processed by the adaptive loop filter, and a filtering operation is performed by using the image data of the taps. The taps are constructed at the locations indicated by black circles and the location of the current pixel.

In a case where the current pixel in the loop filtering process is a pixel on the sixth line from the block boundary BB, as shown in (B) of FIG. 1, the taps are not included in the filtering range of the deblocking filter. Accordingly, the image processing device that performs the loop filtering process can perform the loop filtering process without the use of the image data subjected to the deblocking filtering process. However, in a case where the current pixel in the loop filtering process is a pixel on the fifth line from the block boundary BB, as shown in (C) of FIG. 1, the taps are included in the filtering range of the deblocking filter. That is, the image data subjected to the deblocking filtering process is required in the loop filtering process. Therefore, the image processing device that performs the loop filtering process stores the image data of the seven lines counted from the block boundary BB into the line memory so that the loop filtering process can be performed after the deblocking filtering process.

As described above, in a case where taps are included in the filtering range of the deblocking filter, the image processing device needs to store the image data of a predetermined number of lines counted from the block boundary BB so that the loop filtering process can be performed after the deblocking filtering process. Therefore, where the number of pixels in the horizontal direction is large, a line memory with a large memory capacity is required.

<2. Structure in which the Present Technique is Applied to an Image Encoding Device>

In a case where an image processing device of the present technique is applied to an image encoding device, the image encoding device performs a filtering operation by using the image data of taps constructed for to-be-filtered pixels in a locally decoded image and a coefficient set at the time of image encoding, and performs encoding by using the image subjected to the filtering operation. In a case where tap positions are located within a predetermined range from the boundary, the filtering operation is controlled so that the filtering operation is performed without the use of image data within the predetermined range. The image encoding device also performs encoding on each coding unit having a hierarchical structure.

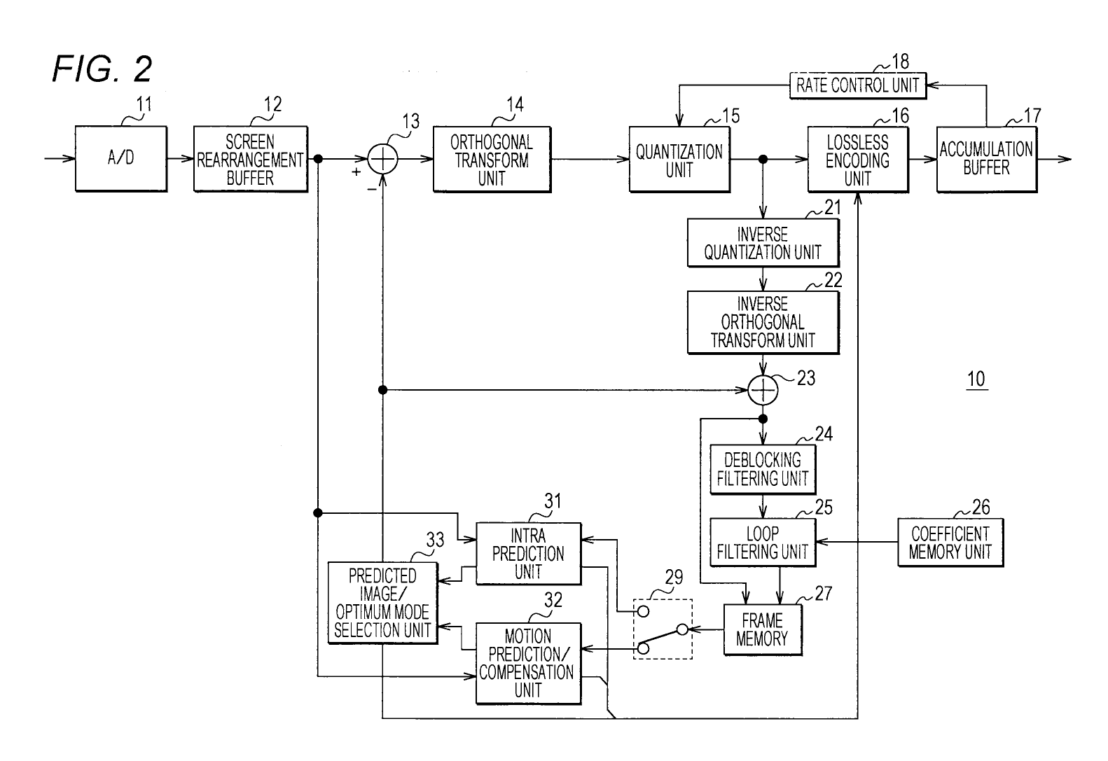

FIG. 2 shows a structure in a case where an image processing device of the present technique is applied to an image encoding device. The image encoding device 10 includes an analog/digital converter (an A/D converter) 11, a screen rearrangement buffer 12, a subtraction unit 13, an orthogonal transform unit 14, a quantization unit 15, a lossless encoding unit 16, an accumulation buffer 17, and a rate control unit 18. The image encoding device 10 further includes an inverse quantization unit 21, an inverse orthogonal transform unit 22, an addition unit 23, a deblocking filtering unit 24, a loop filtering unit 25, a coefficient memory unit 26, a frame memory 27, a selector 29, an intra prediction unit 31, a motion prediction/compensation unit 32, and a predicted image/optimum mode selection unit 33.

The A/D converter 11 converts analog image signals into digital image data, and outputs the image data to the screen rearrangement buffer 12.

The screen rearrangement buffer 12 rearranges the frames of the image data output from the A/D converter 11. The screen rearrangement buffer 12 rearranges the frames in accordance with the GOP (Group of Pictures) structure related to encoding operations, and outputs the rearranged image data to the subtraction unit 13, the intra prediction unit 31, and the motion prediction/compensation unit 32.

The subtraction unit 13 receives the image data output from the screen rearrangement buffer 12 and predicted image data selected by the later described predicted image/optimum mode selection unit 33. The subtraction unit 13 calculates prediction error data that is the difference between the image data output from the screen rearrangement buffer 12 and the predicted image data supplied from the predicted image/optimum mode selection unit 33, and outputs the prediction error data to the orthogonal transform unit 14.

The orthogonal transform unit 14 performs an orthogonal transform operation, such as a discrete cosine transform (DCT) or a Karhunen-Loeve transform, on the prediction error data output from the subtraction unit 13. The orthogonal transform unit 14 outputs transform coefficient data obtained by performing the orthogonal transform operation to the quantization unit 15.

The quantization unit 15 receives the transform coefficient data output from the orthogonal transform unit 14 and a rate control signal supplied from the later described rate control unit 18. The quantization unit 15 quantizes the transform coefficient data, and outputs the quantized data to the lossless encoding unit 16 and the inverse quantization unit 21. Based on the rate control signal supplied from the rate control unit 18, the quantization unit 15 switches quantization parameters (quantization scales), to change the bit rate of the quantized data.

The lossless encoding unit 16 receives the quantized data output from the quantization unit 15, and prediction mode information supplied from the later described intra prediction unit 31, the motion prediction/compensation unit 32, and the predicted image/optimum mode selection unit 33. The prediction mode information contains a macroblock type for identifying a prediction block size in accordance with an intra prediction or an inter prediction, a prediction mode, motion vector information, reference picture information, and the like. The lossless encoding unit 16 performs a lossless encoding process on the quantized data through variable-length coding or arithmetic coding or the like, to generate and output an encoded stream as an encoded image to the accumulation buffer 17. The lossless encoding unit 16 also performs lossless encoding on the prediction mode information, the later described information indicating a coefficient set, and the like, and adds the resultant information to the header information in the encoded stream.

The accumulation buffer 17 accumulates the encoded stream supplied from the lossless encoding unit 16. The accumulation buffer 17 also outputs the accumulated encoded stream at a transmission rate in accordance with the transmission path.

The rate control unit 18 monitors the free space in the accumulation buffer 17, generates a rate control signal in accordance with the free space, and outputs the rate control signal to the quantization unit 15. The rate control unit 18 obtains information indicating the free space from the accumulation buffer 17, for example. When the remaining free space is small, the rate control unit 18 lowers the bit rate of the quantized data through the rate control signal. When the remaining free space in the accumulation buffer 17 is sufficiently large, the rate control unit 18 increases the bit rate of the quantized data through the rate control signal.

The inverse quantization unit 21 inversely quantizes the quantized data supplied from the quantization unit 15. The inverse quantization unit 21 outputs the transform coefficient data obtained by performing the inverse quantization operation to the inverse orthogonal transform unit 22.

The inverse orthogonal transform unit 22 performs an inverse orthogonal transform operation on the transform coefficient data supplied from the inverse quantization unit 21, and outputs the resultant data to the addition unit 23.

The addition unit 23 adds the data supplied from the inverse orthogonal transform unit 22 to the predicted image data supplied from predicted image/optimum mode selection unit 33, to generate decoded image data. The addition unit 23 then outputs the decoded image data to the deblocking filtering unit 24 and the frame memory 27.

The deblocking filtering unit 24 performs filtering to reduce block distortions that occur at the time of image encoding. The deblocking filtering unit 24 performs filtering to remove block distortions from the decoded image data supplied from the addition unit 23 or the image data of a decoded image subjected to a local decoding process, and outputs the image data subjected to the deblocking filtering process to the loop filtering unit 25.

The loop filtering unit 25 performs an adaptive loop filtering (ALF) process, using coefficients supplied from the coefficient memory unit 26 and the decoded image data. At the loop filtering unit 25, a Wiener filter is used as the filter, for example. It is of course possible to use a filter other than a Wiener filter. The loop filtering unit 25 supplies the filtering process result to the frame memory 27, and stores the filtering process result as the image data of a reference image. The loop filtering unit 25 also supplies the information indicating the coefficient set used in the loop filtering process to the lossless encoding unit 16, to incorporate the information into the encoded stream. The coefficient set supplied to the lossless encoding unit 16 is the coefficient set used in the loop filtering process for increasing encoding efficiency.

The frame memory 27 holds the decoded image data supplied from the addition unit 23, and the filtered decoded image data supplied from the loop filtering unit 25 as the image data of reference images.

The selector 29 supplies the reference image data that has not been filtered and has been read from the frame memory 27, to the intra prediction unit 31 to perform intra predictions. The selector 29 supplies the reference image data that has been filtered and has been read from the frame memory 27, to the motion prediction/compensation unit 32 to perform inter predictions.

The intra prediction unit 31 performs intra prediction processes in all candidate intra prediction modes by using the image data that is output from the screen rearrangement buffer 12 and is of the image to be encoded, and the reference image data that has not been filtered and has been read from the frame memory 27. The intra prediction unit 31 further calculates a cost function value in each of the intra prediction modes, and selects an optimum intra prediction mode that is the intra prediction mode with the smallest cost function value calculated or the intra prediction mode with the highest encoding efficiency. The intra prediction unit 31 outputs the predicted image data generated in the optimum intra prediction mode, the prediction mode information about the optimum intra prediction mode, and the cost function value in the optimum intra prediction mode, to the predicted image/optimum mode selection unit 33. The intra prediction unit 31 also outputs the prediction mode information about the intra prediction mode in the intra prediction process in each intra prediction mode to the lossless encoding unit 16, so as to obtain the bit generation rate to be used in the calculation of the cost function values as described later.

The motion prediction/compensation unit 32 performs a motion prediction/compensation process for all prediction block sizes corresponding to macroblocks. Using the filtered reference image data that is read from the frame memory 27, the motion prediction/compensation unit 32 detects motion vectors from images of respective prediction block sizes that are read from the screen rearrangement buffer 12 and are to be encoded. Based on the detected motion vectors, the motion prediction/compensation unit 32 further performs a motion compensation process on the decoded image, to generate a predicted image. The motion prediction/compensation unit 32 also calculates a cost function value of each prediction block size, and selects an optimum inter prediction mode that is the prediction block size with the smallest cost function value or the prediction block size with the highest encoding efficiency. In selecting the optimum inter prediction mode, the reference image data filtered for each coefficient set by the loop filtering unit, and the optimum inter prediction mode is selected by taking into account the coefficient set. The motion prediction/compensation unit 32 outputs the predicted image data generated in the optimum inter prediction mode, the prediction mode information about the optimum inter prediction mode, and the cost function value in the optimum inter prediction mode, to the predicted image/optimum mode selection unit 33. To obtain the bit generation rate to be used in the calculation of the cost function values, the motion prediction/compensation unit 32 also outputs the prediction mode information about the inter prediction mode to the lossless encoding unit 16 in the inter prediction process for each block size.

The predicted image/optimum mode selection unit 33 compares the cost function value supplied from the intra prediction unit 31 with the cost function value supplied from the motion prediction/compensation unit 32 on a macroblock basis, and selects the smaller cost function value as the optimum mode with the highest encoding efficiency. The predicted image/optimum mode selection unit 33 also outputs the predicted image data generated in the optimum mode to the subtraction unit 13 and the addition unit 23. Further, the predicted image/optimum mode selection unit 33 outputs the prediction mode information about the optimum mode to the lossless encoding unit 16. The predicted image/optimum mode selection unit 33 may perform intra predictions or inter predictions on a slice basis.

It should be noted that the encoding unit in the claims is formed with the intra prediction unit 31 and the motion prediction/compensation unit 32 that generate predicted image data, the predicted image/optimum mode selection unit 33, the subtraction unit 13, the orthogonal transform unit 14, the quantization unit 15, the lossless encoding unit 16, and the like.

### <3. Operation of the Image Encoding Device>

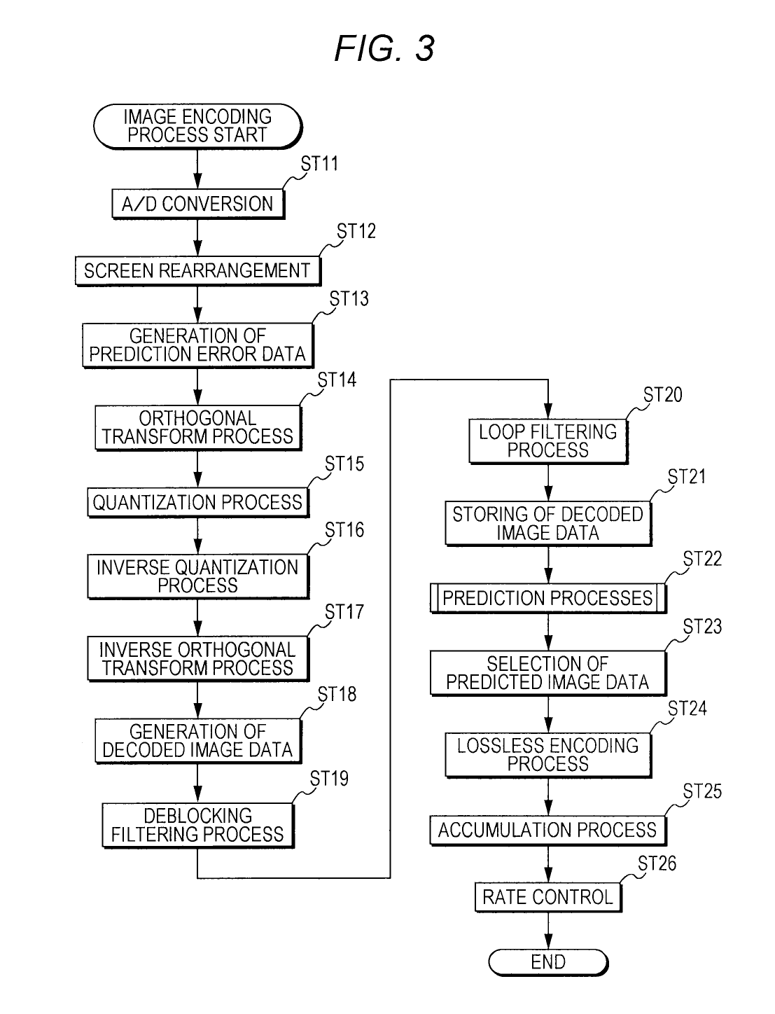

FIG. 3 is a flowchart showing an image encoding operation. In step ST11, the A/D converter 11 performs an A/D conversion on an input image signal.

In step ST12, the screen rearrangement buffer 12 performs screen rearrangement. The screen rearrangement buffer 12 stores the image data supplied from the A/D converter 11, and rearranges the respective pictures in encoding order, instead of displaying order.

In step ST13, the subtraction unit 13 generates prediction error data. The subtraction unit 13 generates the prediction error data by calculating the difference between the image data of the image rearranged in step ST12 and predicted image data selected by the predicted image/optimum mode selection unit 33. The prediction error data has a smaller data amount than the original image data. Accordingly, the data amount can be made smaller than in a case where images are directly encoded. In a case where the predicted image/optimum mode selection unit 33 selects a predicted image supplied from the intra prediction unit 31 or a predicted image from the motion prediction/compensation unit 32 on a slice basis, an intra prediction is performed for each slice in which a predicted image supplied from the intra prediction unit 31 is selected. Meanwhile, an inter prediction is performed for each slice in which a predicted image from the motion prediction/compensation unit 32 is selected.

In step ST14, the orthogonal transform unit 14 performs an orthogonal transform process. The orthogonal transform unit 14 orthogonally transforms the prediction error data supplied from the subtraction unit 13. Specifically, an orthogonal transform such as a discrete cosine transform or a Karhunen-Loeve transform is performed on the prediction error data, and transform coefficient data is output.

In step ST15, the quantization unit 15 performs a quantization process. The quantization unit 15 quantizes the transform coefficient data. In the quantization, rate control is performed as will be described later in the description of step ST26.

In step ST16, the inverse quantization unit 21 performs an inverse quantization process. The inverse quantization unit 21 inversely quantizes the transform coefficient data quantized by the quantization unit 15, having characteristics compatible with the characteristics of the quantization unit 15.

In step ST17, the inverse orthogonal transform unit 22 performs an inverse orthogonal transform process. The inverse orthogonal transform unit 22 performs an inverse orthogonal transform on the transform coefficient data inversely quantized by the inverse quantization unit 21, having the characteristics compatible with the characteristics of the orthogonal transform unit 14.

In step ST18, the addition unit 23 generates decoded image data. The addition unit 23 generates the decoded image data by adding the predicted image data supplied from the predicted image/optimum mode selection unit 33 to the data that has been subjected to the inverse orthogonal transform and is located in the position corresponding to the predicted image.

In step ST19, the deblocking filtering unit 24 performs a deblocking filtering process. The deblocking filtering unit 24 removes block distortions by filtering the decoded image data output from the addition unit 23.

In step ST20, the loop filtering unit 25 performs a loop filtering process. The loop filtering unit 25 performs filtering on the decoded image data subjected to the deblocking filtering process, and reduces block distortions remaining after the deblocking filtering process and distortions caused by the quantization.

In step ST21, the frame memory 27 stores the decoded image data. The frame memory 27 stores the decoded image data that has not been subjected to the deblocking filtering process and the decoded image data that has been subjected to the loop filtering process.

In step ST22, the intra prediction unit 31 and the motion prediction/compensation unit 32 each perform prediction processes. Specifically, the intra prediction unit 31 performs intra prediction processes in intra prediction modes, and the motion prediction/compensation unit 32 performs motion prediction/compensation processes in inter prediction modes. In this step, prediction processes are performed in all the candidate prediction modes, and cost function values are calculated in all the candidate prediction modes. Based on the calculated cost function values, an optimum intra prediction mode and an optimum inter prediction mode are selected, and the predicted images generated in the selected prediction modes, the corresponding cost functions, and the corresponding prediction mode information are supplied to the predicted image/optimum mode selection unit 33.

In step ST23, the predicted image/optimum mode selection unit 33 selects predicted image data. Based on the respective cost function values output from the intra prediction unit 31 and the motion prediction/compensation unit 32, the predicted image/optimum mode selection unit 33 determines the optimum mode to optimize the encoding efficiency. The predicted image/optimum mode selection unit 33 further selects the predicted image data in the determined optimum mode, and supplies the selected predicted image data to the subtraction unit 13 and the addition unit 23. This predicted image is used in the calculations in steps ST13 and ST18, as described above.

In step ST24, the lossless encoding unit 16 performs a lossless encoding process. The lossless encoding unit 16 performs lossless encoding on the quantized data output from the quantization unit 15. That is, lossless encoding such as variable-length coding or arithmetic coding is performed on the quantized data, to compress the data. At this point, lossless encoding is also performed on the prediction mode information (including the macroblock type, the prediction mode, the motion vector information, the reference picture information, and the like) that is input to the lossless encoding unit 16 in step ST22 as described above, and the coefficient set. Further, the lossless-encoded data of the prediction mode information is added to the header information in the encoded stream generated by performing lossless encoding on the quantized data.

In step ST25, the accumulation buffer 17 accumulates the encoded stream by performing an accumulation process. The encoded stream accumulated in the accumulation buffer 17 is read where appropriate, and is transmitted to the decoding side via a transmission path.

In step ST26, the rate control unit 18 performs rate control. The rate control unit 18 controls the quantization operation rate of the quantization unit 15 so that an overflow or an underflow does not occur in the accumulation buffer 17 when the accumulation buffer 17 accumulates encoded streams.

Next, the prediction processes in step ST22 of FIG. 3 are described. In the prediction processes, intra prediction processes and inter prediction processes are performed. In the intra prediction processes, intra predictions are performed on the image of the current block in all the candidate intra prediction modes. The image data of the reference image to be referred to in the intra predictions are the reference image data that is stored in the frame memory 27 and has not been filtered by the deblocking filtering unit 24 and the loop filtering unit 25. In the intra prediction processes, which will be described later in detail, intra predictions are performed in all the candidate intra prediction modes, and cost function values are calculated in all the candidate intra prediction modes. Based on the calculated cost function values, the intra prediction mode with the highest encoding efficiency is selected from all the intra prediction modes.

In the inter prediction processes, inter predictions are performed in all the candidate inter prediction modes (all the prediction block sizes) by using the filtered reference image data that is stored in the frame memory 27. In the inter prediction processes, which will be described later in detail, prediction processes are performed in all the candidate inter prediction modes, and cost function values are calculated in all the candidate inter prediction modes. Based on the calculated cost function values, the inter prediction mode with the highest encoding efficiency is selected from all the inter prediction modes.

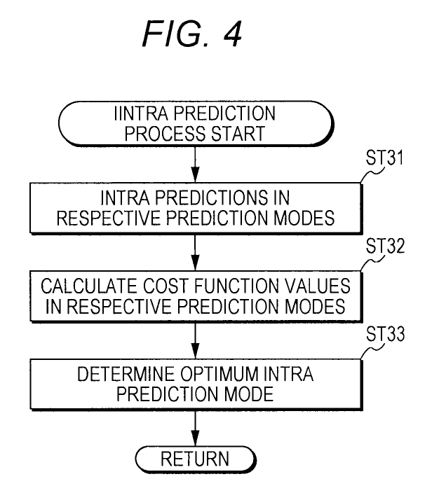

Referring now to the flowchart in FIG. 4, the intra prediction processes are described. In step ST31, the intra prediction unit 31 performs intra prediction processes in the respective prediction modes. Using the decoded image data that is stored in the frame memory 27 and has not been filtered, the intra prediction unit 31 generates predicted image data in each intra prediction mode.

In step ST32, the intra prediction unit 31 calculates the cost function value in each prediction mode. For example, the operation that ends with the lossless encoding process is provisionally performed in all the candidate prediction modes, to calculate the cost function value expressed by the following equation (1) in each prediction mode.

Cost(ModeεΩ)=D+λ·R (1)

Here, Ω represents the universal set of the candidate prediction modes for encoding the block or macroblock. D represents the energy difference (distortion) between the decoded image and the input image in a case where encoding is performed in a prediction mode. R represents the bit generation rate including orthogonal transform coefficients and prediction mode information, and λ represents the Lagrange multiplier given as the function of a quantization parameter QP.

Meanwhile, the generation of a predicted image and the calculation of the header bit such as motion vector information and prediction mode information are in all the candidate prediction modes, and the cost function value expressed by the following equation (2) is calculated in each prediction mode.

Cost(ModeεΩ)=D+QPtoQuant(QP)·Header_Bit (2)

Here, Ω represents the universal set of the candidate prediction modes for encoding the block or macroblock. D represents the energy difference (distortion) between the decoded image and the input image in a case where encoding is performed in a prediction mode. Header_Bit represents the header bit corresponding to the prediction mode, and QPtoQuant is the function given as a function of the quantization parameter QP.

In step ST33, the intra prediction unit 31 determines the optimum intra prediction mode. Based on the cost function values calculated in step ST32, the intra prediction unit 31 selects the one intra prediction mode with the smallest cost function value among the calculated cost function values, and determines the selected intra prediction mode to be the optimum intra prediction mode.

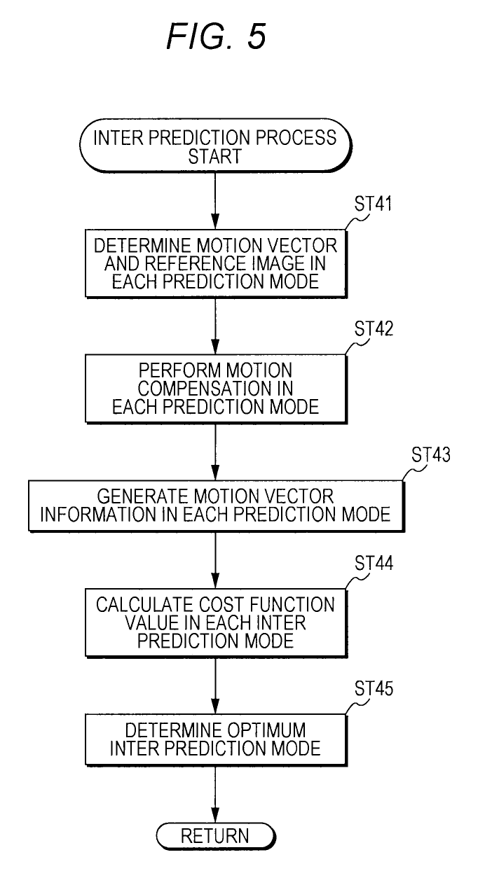

Referring now to the flowchart in FIG. 5, the inter prediction processes are described. In step ST41, the motion prediction/compensation unit 32 determines a motion vector and a reference image for each prediction mode. That is, the motion prediction/compensation unit 32 determines a motion vector and a reference image for the current block in each prediction mode.

In step ST42, the motion prediction/compensation unit 32 performs motion compensation in each prediction mode. Based on the motion vector determined in step ST41, the motion prediction/compensation unit 32 performs motion compensation on the reference image in each prediction mode (each prediction block size), and generates predicted image data in each prediction mode.

In step ST43, the motion prediction/compensation unit 32 generates motion vector information in each prediction mode. For the motion vectors determined in the respective prediction modes, the motion prediction/compensation unit 32 generates the motion vector information to be incorporated into the encoded stream. For example, a predicted motion vector is determined by using a median prediction or the like, and motion vector information indicating the difference between a motion vector detected through a motion prediction and the predicted motion vector is generated. The motion vector information generated in this manner is also used in calculating the cost function values in the next step ST44, and is eventually incorporated into the prediction mode information to be output to the lossless encoding unit 16 when the corresponding predicted image is selected by the predicted image/optimum mode selection unit 33.

In step ST44, the motion prediction/compensation unit 32 calculates cost function values in the respective inter prediction modes. Using the above mentioned equation (1) or (2), the motion prediction/compensation unit 32 calculates the cost function values.

In step ST45, the motion prediction/compensation unit 32 determines the optimum inter prediction mode. Based on the cost function values calculated in step ST44, the motion prediction/compensation unit 32 selects the one prediction mode with the smallest cost function value among the calculated cost function values, and determines the selected prediction mode to be the optimum inter prediction mode.

<4. Structure in which the Present Technique is Applied to an Image Decoding Device>

An encoded stream generated by encoding an input image is supplied to an image decoding device via a predetermined transmission path or a recording medium or the like, and is decoded therein.

In a case where an image processing device of the present technique is applied to an image decoding device, the image decoding device performs a filtering operation by using the image data of taps constructed for the to-be-filtered pixels in an image generated by decoding an encoded stream generated by encoding an image, and a coefficient set. In a case where tap positions are located within a predetermined range from the boundary, the filtering operation is controlled so that the filtering operation is performed without the use of image data within the predetermined range. The encoded stream is data that has a hierarchical structure and has been encoded on a coding unit basis.

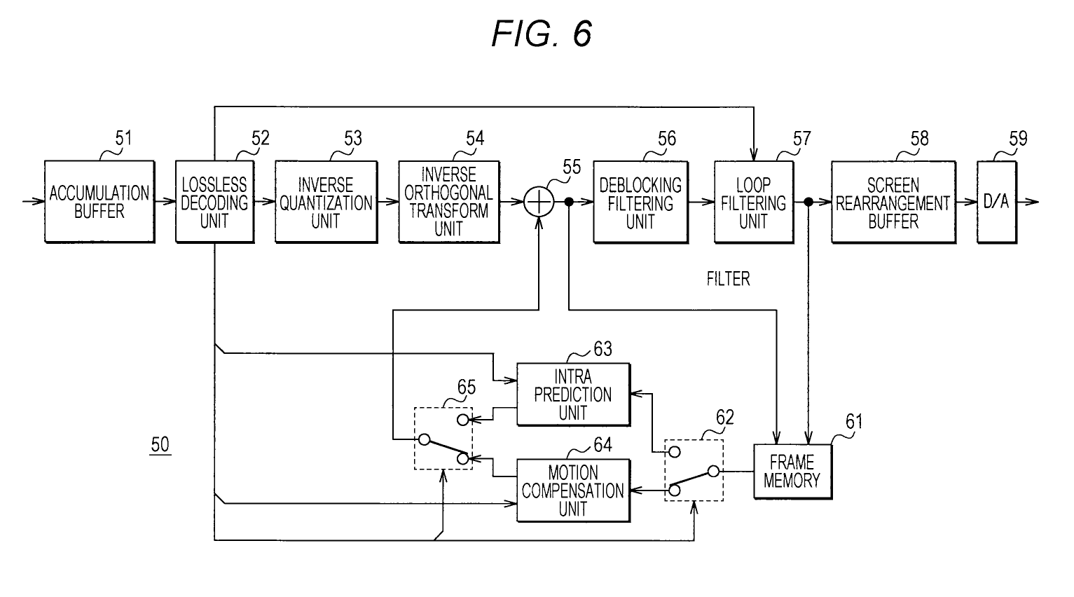

FIG. 6 shows a structure in a case where an image processing device of the present technique is applied to an image decoding device. The image decoding device 50 includes an accumulation buffer 51, a lossless decoding unit 52, an inverse quantization unit 53, an inverse orthogonal transform unit 54, an addition unit 55, a deblocking filtering unit 56, a loop filtering unit 57, a screen rearrangement buffer 58, and a D/A converter 59. The image decoding device 50 further includes a frame memory 61, selectors 62 and 65, an intra prediction unit 63, and a motion compensation unit 64.

The accumulation buffer 51 accumulates transmitted encoded streams. The lossless decoding unit 52 decodes an encoded stream supplied from the accumulation buffer 51 by a method corresponding to the encoding method used by the lossless encoding unit 16 shown in FIG. 2. The lossless decoding unit 52 also outputs the prediction mode information obtained by decoding the header information in the encoded stream to the intra prediction unit 63 and the motion compensation unit 64, and outputs the coefficient set for loop filtering processes to the loop filtering unit 57.

The inverse quantization unit 53 inversely quantizes the quantized data decoded by the lossless decoding unit 52 using a method corresponding to the quantization method used by the quantization unit 15 shown in FIG. 2. The inverse orthogonal transform unit 54 performs an inverse orthogonal transform on the output from the inverse quantization unit 53 by a method corresponding to the orthogonal transform method used by the orthogonal transform unit 14 shown in FIG. 2, and outputs the result to the addition unit 55.

The addition unit 55 generates decoded image data by adding the data subjected to the inverse orthogonal transform to predicted image data supplied from the selector 65, and outputs the decoded image data to the deblocking filtering unit 56 and the frame memory 61.

The deblocking filtering unit 56 performs filtering on the decoded image data supplied from the addition unit 55 to remove block distortions, and outputs the result to the loop filtering unit 57.

The loop filtering unit 57 has the same structure as the loop filtering unit 25 shown in FIG. 2, and performs a loop filtering process on the image data subjected to the deblocking filtering process based on the information about the coefficient set obtained from the encoded stream by the lossless decoding unit 52. The loop filtering unit 57 supplies the filtered image data to the frame memory 61 to accumulate the filtered image data, and also outputs the filtered image data to the screen rearrangement buffer 58.

The screen rearrangement buffer 58 performs image rearrangement. Specifically, the frame order rearranged in the order of encoding by the screen rearrangement buffer 12 shown in FIG. 2 is rearranged in the original displaying order, and is output to the D/A converter 59.

The D/A converter 59 performs a D/A conversion on the image data supplied from the screen rearrangement buffer 58, and outputs the converted image data to a display (not shown) to display the image.

The frame memory 61 holds the decoded image data that has not been filtered and has been supplied from the addition unit 55, and the filtered decoded image data supplied from the loop filtering unit 57 as the image data of reference images.

When a prediction block subjected to an intra prediction is decoded based on the prediction mode information supplied from the lossless decoding unit 52, the selector 62 supplies the reference image data that has not been filtered and has been read from the frame memory 61, to the intra prediction unit 63. When a prediction block subjected to an inter prediction is decoded based on the prediction mode information supplied from the lossless decoding unit 52, the selector 29 supplies the filtered reference image data read from the frame memory 61 to the motion compensation unit 64.

The intra prediction unit 63 generates predicted images based on the prediction mode information supplied from the lossless decoding unit 52, and outputs the generated predicted image data to the selector 65.

The motion compensation unit 64 performs motion compensation based on the prediction mode information supplied from the lossless decoding unit 52 to generate predicted image data, and outputs the generated predicted image data to the selector 65. Specifically, based on the motion vector information and the reference frame information contained in the prediction mode information, the motion compensation unit 64 generates predicted image data by performing motion compensation on the reference image indicated by the reference frame information with the motion vectors indicated by the motion vector information.

The selector 65 outputs the predicted image data generated by the intra prediction unit 63 to the addition unit 55. The selector 65 also supplies the predicted image data generated by the motion compensation unit 64 to the addition unit 55.

The decoding unit in the claims is formed with the lossless decoding unit 52, the inverse quantization unit 53, the inverse orthogonal transform unit 54, the addition unit 55, the intra prediction unit 63, the motion compensation unit 64, and the like.

### <5. Operation of the Image Decoding Device>

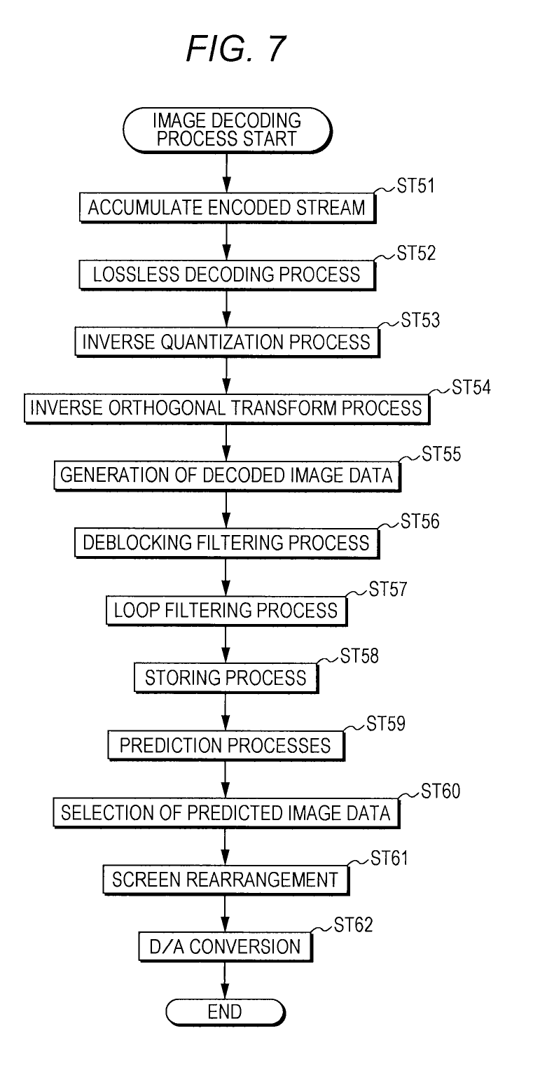

Referring now to the flowchart in FIG. 7, an image decoding operation to be performed by the image decoding device 50 is described.

In step ST51, the accumulation buffer 51 accumulates a transmitted encoded stream. In step ST52, the lossless decoding unit 52 performs a lossless decoding process. The lossless decoding unit 52 decodes an encoded stream supplied from the accumulation buffer 51. Specifically, the quantized data of each picture encoded by the lossless encoding unit 16 shown in FIG. 2 is obtained. The lossless decoding unit 52 also performs lossless decoding on the prediction mode information contained in the header information in the encoded stream, and supplies the obtained prediction mode information to the deblocking filtering unit 56 and the selectors 62 and 65. Further, when the prediction mode information is information about intra prediction modes, the lossless decoding unit 52 outputs the prediction mode information to the intra prediction unit 63. When the prediction mode information is information about inter prediction modes, on the other hand, the lossless decoding unit 52 outputs the prediction mode information to the motion compensation unit 64. The lossless decoding unit 52 also outputs the coefficient set for loop filtering processes obtained by decoding the encoded stream, to the loop filtering unit 57.

In step ST53, the inverse quantization unit 53 performs an inverse quantization process. The inverse quantization unit 53 inversely quantizes the quantized data decoded by the lossless decoding unit 52, having characteristics compatible with the characteristics of the quantization unit 15 shown in FIG. 2.

In step ST54, the inverse orthogonal transform unit 54 performs an inverse orthogonal transform process. The inverse orthogonal transform unit 54 performs an inverse orthogonal transform on the transform coefficient data inversely quantized by the inverse quantization unit 53, having characteristics compatible with the characteristics of the orthogonal transform unit 14 shown in FIG. 2.

In step ST55, the addition unit 55 generates decoded image data. The addition unit 55 adds the data obtained through the inverse orthogonal transform operation to predicted image data selected in step ST60, which will be described later, and generates the decoded image data. In this manner, the original images are decoded.

In step ST56, the deblocking filtering unit 56 performs a deblocking filtering process. The deblocking filtering unit 56 performs filtering on the decoded image data output from the addition unit 55, and removes block distortions contained in the decoded image.

In step ST57, the loop filtering unit 57 performs a loop filtering process. The loop filtering unit 57 performs filtering on the decoded image data subjected to the deblocking filtering process, and reduces block distortions remaining after the deblocking filtering process and distortions caused by the quantization.

In step ST58, the frame memory 61 performs a decoded image data storing process.

In step ST59, the intra prediction unit 63 and the motion compensation unit 64 perform prediction processes. The intra prediction unit 63 and the motion compensation unit 64 each perform prediction processes in accordance with the prediction mode information supplied from the lossless decoding unit 52.

Specifically, when the prediction mode information about intra predictions is supplied from the lossless decoding unit 52, the intra prediction unit 63 performs intra prediction processes based on the prediction mode information, to generate predicted image data. When prediction mode information about inter predictions is supplied from the lossless decoding unit 52, on the other hand, the motion compensation unit 64 performs motion compensation based on the prediction mode information, to generate predicted image data.

In step ST60, the selector 65 selects predicted image data. Specifically, the selector 65 selects the predicted image supplied from the intra prediction unit 63 and the predicted image data generated by the motion compensation unit 64, and supplies the selected predicted image data to the addition unit 55, which adds the selected predicted image data to the output from the inverse orthogonal transform unit 54 in step ST55, as described above.

In step ST61, the screen rearrangement buffer 58 performs image rearrangement. Specifically, the order of frames rearranged for encoding by the screen rearrangement buffer 12 of the image encoding device 10 shown in FIG. 2 is rearranged in the original displaying order by the screen rearrangement buffer 58.

In step ST62, the D/A converter 59 performs a D/A conversion on the image data supplied from the screen rearrangement buffer 58. This image is output to the display (not shown), and is displayed thereon.

### <6. Fundamental Structure and Operation of the Loop Filtering Unit>

The loop filtering unit 25 of the image encoding device 10 shown in FIG. 2 and the loop filtering unit 57 of the image decoding device shown in FIG. 6 have the same structures, operate in the same manner, and are equivalent to image processing devices of the present technique.

A loop filtering unit constructs taps and a coefficient set for the current pixel in an image subjected to a deblocking process in an encoding process and a decoding process performed for each block, and performs a filtering operation by using the image data of the taps and the coefficient set. Also, in a case where the tap positions in the block are determined to be within a predetermined range from a boundary, a filtering operation is performed without the use of image data within the predetermined range. For example, in a case where the tap positions are within the filtering range of the deblocking filter, which is a predetermined range from the lower block boundary, the image data of taps located within the predetermined range is replaced, or the coefficient set is changed, so that a filtering operation can be performed without the use of image data within the predetermined range.

The structure and operation of the loop filtering unit 25 are described below in detail. As for the loop filtering unit 57, only the portions different from the loop filtering unit 25 are described. In a case where a coding unit having a hierarchical structure is encoded or decoded, the boundaries are those of a predetermined range in the largest coding unit among coding units.

### <7. First Embodiment of the Loop Filtering Unit>

### [Structure of the Loop Filtering Unit]

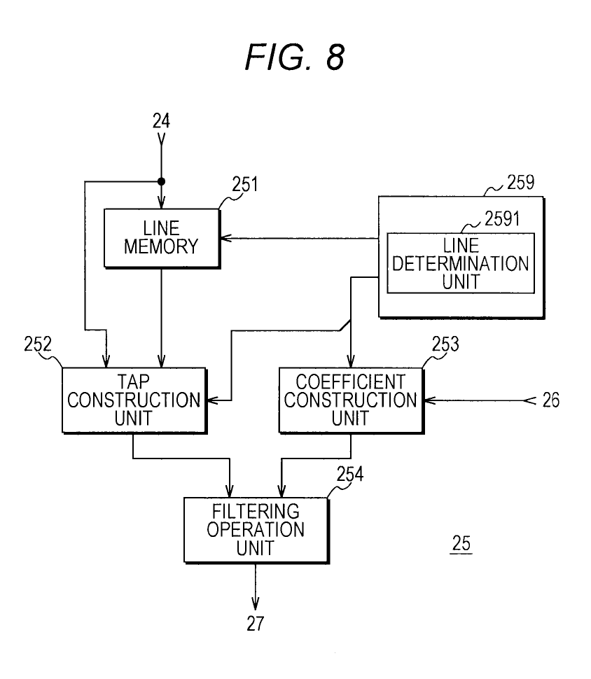

FIG. 8 shows the structure of a first embodiment of the loop filtering unit. The loop filtering unit 25 includes a line memory 251, a tap construction unit 252, a coefficient construction unit 253, a filtering operation unit 254, and a filter control unit 259.

Image data that is output from the deblocking filtering unit 24 is supplied to the line memory 251 and the tap construction unit 252.

Based on a control signal from the filter control unit 259, the line memory 251 stores image data of a predetermined number of lines counted from the lower block boundary of the current block to be subjected to the loop filtering process. The line memory 251 also reads stored image data based on the control signal, and outputs the image data to the tap construction unit 252.

Using the image data supplied from the deblocking filtering unit 24 and the image data stored in the line memory 251, the tap construction unit 252 constructs taps based on the current pixel being processed by the loop filter. The tap construction unit 252 outputs the image data of the constructed taps to the filtering operation unit 254.

The coefficient construction unit 253 reads coefficients to be used in the filtering operation from the coefficient memory unit 26, determines the coefficients corresponding to the taps constructed by the tap construction unit 252, and constructs a coefficient set including the coefficients of the respective taps. The coefficient construction unit 253 outputs the constructed coefficient set to the filtering operation unit 254. It should be noted that the coefficient construction unit of the loop filtering unit 57 uses a coefficient set supplied from the lossless decoding unit 52.

The filtering operation unit 254 performs an operation by using the image data of the taps supplied from the tap construction unit 252 and the coefficients supplied from the coefficient construction unit 253, to generate image data subjected to the loop filtering process.

The filter control unit 259 supplies the control signal to the line memory 251, to control the storing of image data into the line memory 251 and the reading of stored image data. The filter control unit 259 includes a line determination unit 2591. When the line determination unit 2591 determines that the tap positions are determined to be located within a predetermined range from the lower block boundary or within the filtering range of the deblocking filter, the filter control unit 259 replaces the image data of the taps set by the tap construction unit 252, or changes the coefficient set to be constructed by the coefficient construction unit 253, so that a filtering operation can be performed without the use of image data within the predetermined range.

### [Operation of the Loop Filtering Unit]

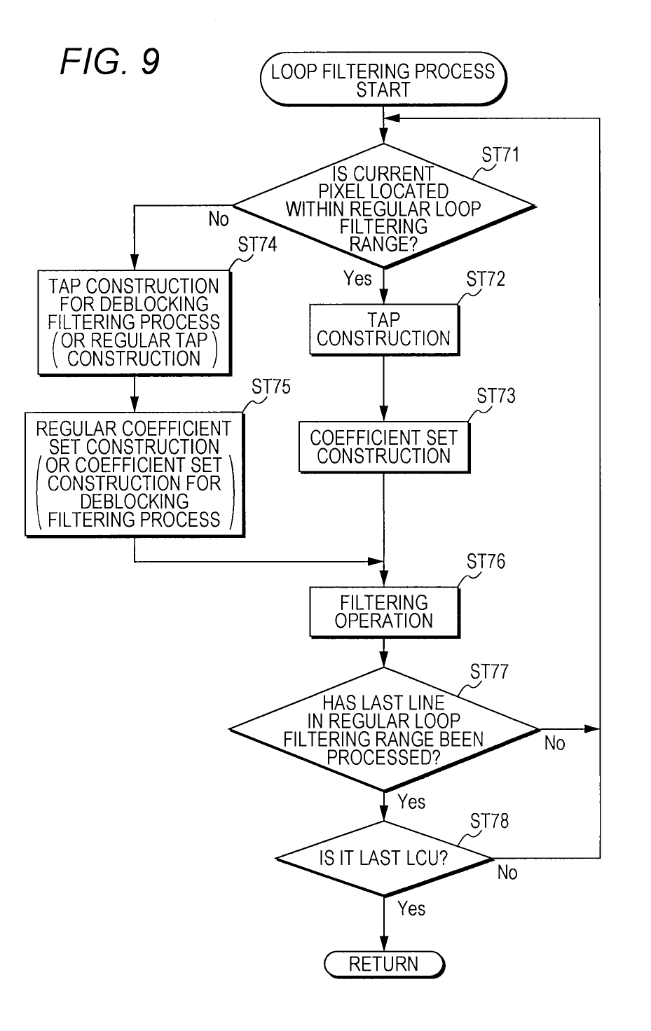

FIG. 9 is a flowchart showing an operation of the first embodiment of the loop filtering unit 25. In step ST71, the loop filtering unit 25 determines whether the current pixel is located within a regular loop filtering range. The loop filtering unit 25 determines whether the line position of the current pixel being processed by the loop filter is such a position that taps in the filtering range of the deblocking filter are not included. If taps are not included in the filtering range of the deblocking filter, the loop filtering unit 25 determines that the line position is located within the regular loop filtering range, and moves on to step ST72. If one or more taps are included in the filtering range of the deblocking filter, the loop filtering unit 25 determines that the line position is outside the regular loop filtering range, and moves on to step ST74.

In step ST72, the loop filtering unit 25 constructs taps. The loop filtering unit 25 constructs the taps based on the current pixel being processed by the loop filter, and moves on to step ST73.

In step ST73, the loop filtering unit 25 constructs a coefficient set. The loop filtering unit 25 reads coefficients from the coefficient memory unit 26, constructs the coefficient set indicating the coefficients for the taps, and then moves on to step ST76.

In step ST74 or ST75, the loop filtering unit 25 constructs taps for the deblocking filtering process, or constructs a coefficient set for the deblocking filtering process.

When constructing taps for the deblocking filtering process, the loop filtering unit 25 in step ST74 replaces the image data of the taps located within the filtering process, so that the pixels located on the outer periphery of a boundary of the filtering range of the deblocking filter are copied in the vertical direction and are used as taps within the filtering range, for example.

When constructing a coefficient set for the deblocking filtering process, the loop filtering unit 25 in step ST75 changes the coefficient set, so that the pixels located on the outer periphery of a boundary of the filtering range of the deblocking filter are copied in the vertical direction and are used as taps within the filtering range, for example.

In step ST76, the loop filtering unit 25 performs a filtering operation. The loop filtering unit 25 performs the filtering operation by using the taps and the coefficient set constructed by the processing in steps ST72 through ST75, and calculates the image data subjected to the loop filtering process for the current pixel.

In step ST77, the loop filtering unit 25 determines whether the last line in the regular loop filtering range has been processed. If the last line in the regular loop filtering range in the LCU (Largest Coding Unit) has not been subjected to the loop filtering process, the loop filtering unit 25 returns to step ST71, and performs the loop filtering process on the next line position. If the last line has been subjected to the loop filtering process, the loop filtering unit 25 moves on to step ST78.

In step ST78, the loop filtering unit 25 determines whether the current LCU is the last LCU. If the current LCU subjected to the loop filtering process is not the last LCU, the loop filtering unit 25 returns to step ST71, and performs the loop filtering process on the next LCU. If the current LCU subjected to the loop filtering process is the last LCU, the loop filtering unit 25 ends the loop filtering process.

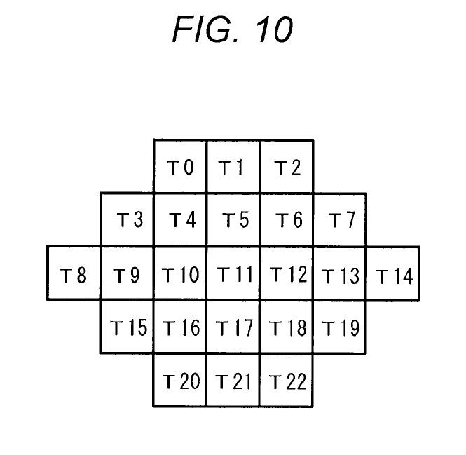

FIG. 10 shows an example of a tap shape formed with respect to the current pixel being processed by the loop filter. The tap shape is a rhombic formed around the current pixel being processed by the loop filter, with seven taps being aligned in the horizontal direction and five taps in the vertical direction. The current pixel being processed by the loop filter is located in the position of a tap T11.

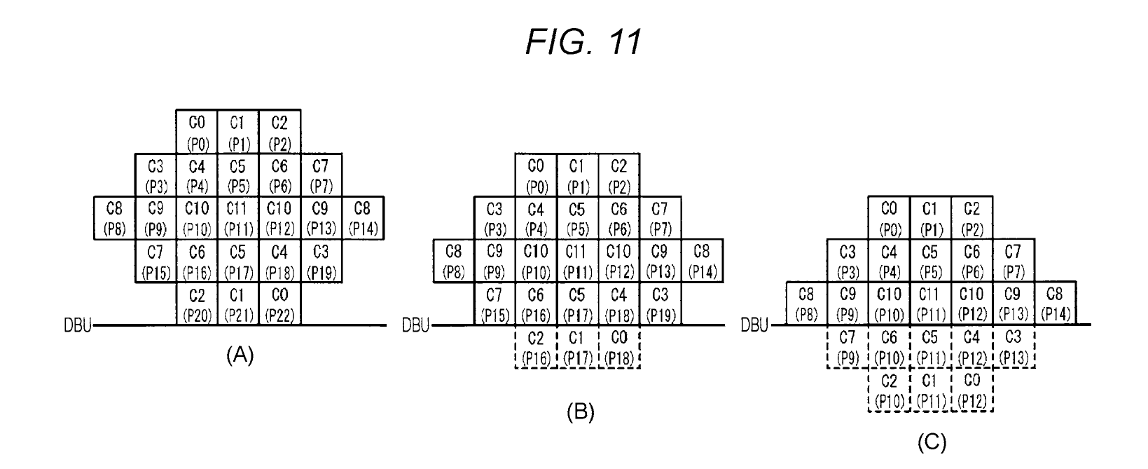

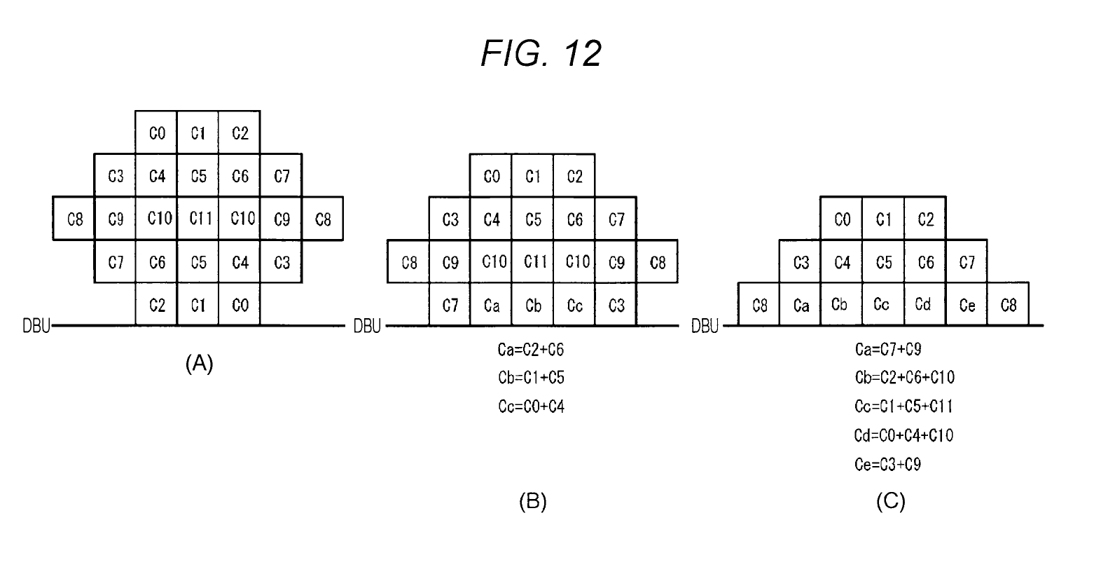

FIG. 11 shows examples of tap constructions for the deblocking filtering process, and FIG. 12 shows examples of coefficient set constructions for the deblocking filtering process. In FIGS. 11 and 12, “C0 through C11 and Ca through Ce” represent coefficients, and “P0 through P22” represent the image data of respective taps. In the following description, “DBU” represents the upper boundary of the filtering range of the deblocking filter.

(A) of FIG. 11 shows a case where the current pixel being processed by the loop filter is located in such a line position that taps are not included in the filtering range of the deblocking filter. (B) and (C) of FIG. 11 each show a case where the current pixel is located in such a line position that taps are included in the filtering range of the deblocking filter. In the cases illustrated in (B) and (C) of FIG. 11, the loop filtering unit 25 replaces the image data of the taps located within the filtering process, so that the pixels located on the outer periphery of the boundary of the filtering range of the deblocking filter are copied in the vertical direction and are used as taps within the filtering range.

Specifically, as shown in (B) of FIG. 11, the image data P16 of a tap T16 is used as the image data of a tap T20 within the filtering range of the deblocking filter. Likewise, the image data P17 of a tap T17 is used as the image data of a tap T21 within the filtering range, and the image data P18 of a tap T18 is used as the image data of a tap T22.

Also, as shown in (C) of FIG. 11, the image data P10 of a tap T10 is used as the image data of taps T16 and T20 within the filtering range of the deblocking filter. Likewise, the image data P11 of a tap T11 is used as the image data of the taps T17 and T21 within the filtering range, and the image data P12 of a tap T12 is used as the image data of the taps T18 and T22.

(A) of FIG. 12 shows a case where the current pixel being processed by the loop filter is located in such a line position that taps are not included in the filtering range of the deblocking filter. (B) and (C) of FIG. 12 each show a case where the current pixel is located in such a line position that taps are included in the filtering range of the deblocking filter. In the cases illustrated in (B) and (C) of FIG. 12, the loop filtering unit 25 changes the coefficient set, so that the pixels located on the outer periphery of the boundary of the filtering range of the deblocking filter are copied in the vertical direction and are used as taps within the filtering range.

Specifically, as shown in (B) of FIG. 12, the coefficient of the tap T20 within the filtering range of the deblocking filter is added to the coefficient of the tap T16 located on the outer periphery of the boundary of the filtering range, to generate a coefficient Ca (=C2+C6). Likewise, the coefficient of the tap T21 is added to the coefficient of the tap T17 to generate a coefficient Cb (=C1+C5), and the coefficient of the tap T22 is added to the coefficient of the tap T18 to generate a coefficient Cc (=C0+C4). Meanwhile, the coefficients of the taps within the filtering range of the deblocking filter are set to “0”.

Also, as shown in (C) of FIG. 12, the coefficient of a tap T7 within the filtering range of the deblocking filter is added to the coefficient of a tap T9 located on the outer periphery of the boundary of the filtering range, to generate a coefficient Ca (=C7+C9). Likewise, the coefficients of the taps T16 and T20 are added to the coefficient of the tap T10 to generate a coefficient Cb (=C2+C6+C10), and the coefficients of the taps T17 and T21 are added to the coefficient of the tap T11 to generate a coefficient Cc (=C1+C5+C11). Further, the coefficients of the taps T18 and T22 are added to the coefficient of a tap T12 to generate a coefficient Cd (=C0+C4+C10), and the coefficient of a tap T19 is added to the coefficient of a tap T13 to generate a coefficient Ce (=C3+C9). Meanwhile, the coefficients of the taps within the filtering range of the deblocking filter are set to “0”.

As described above, in a case where some of the taps are included in the filtering range of the deblocking filter, taps for the deblocking filtering process or a coefficient set for the deblocking filtering process is constructed. Accordingly, the loop filtering process can be performed without the use of image data subjected to the deblocking filtering process, and the memory capacity of the line memory that stores image data so as to allow the loop filtering process after the deblocking filtering process can be reduced.

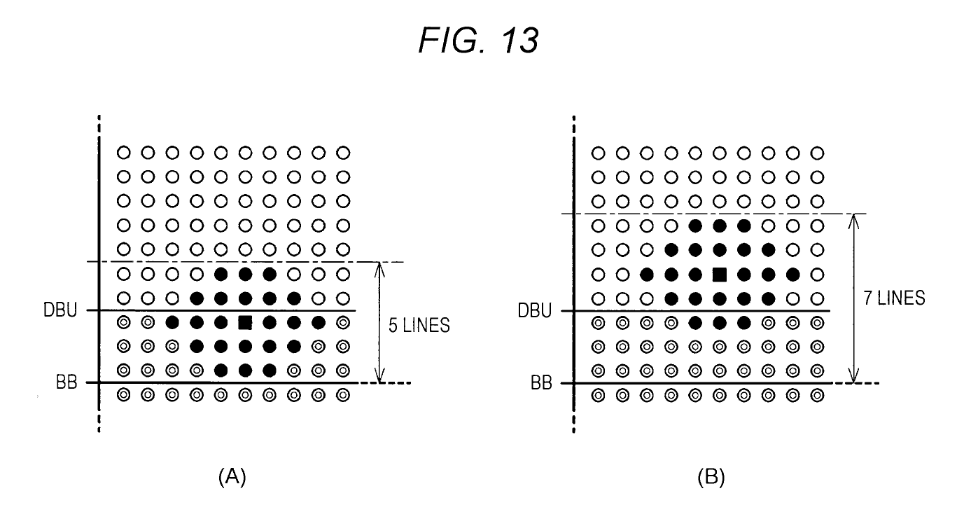

For example, in a case where the processing illustrated in (B) and (C) of FIG. 11 or (B) and (C) of FIG. 12 is performed, image data subjected to the deblocking filtering process is required when the current pixel being processed by the loop filter is a pixel on the third line from the block boundary BB, as shown in (A) of FIG. 13. Therefore, the image data of the five lines counted from the block boundary BB is stored into the line memory so that the loop filtering process can be performed after the deblocking filtering process. (B) of FIG. 13 shows a case where the image data of seven lines is stored into the line memory when the present technique is not used.

### <8. Second Embodiment of the Loop Filtering Unit>

A second embodiment of the loop filtering unit differs from the first embodiment in the operations to construct taps for the deblocking filtering process and a coefficient set for the deblocking filtering process.

When constructing taps for the deblocking filtering process, the loop filtering unit 25 sets a mirror copying axis that is formed with the positions of the pixels located on the outer periphery of a boundary of the filtering range of the deblocking filter. Further, the loop filtering unit 25 replaces the image data of taps located within the filtering range so that the pixels having mirror copies thereof formed on taps within the filtering range are used.

When constructing a coefficient set for the deblocking filtering process, the loop filtering unit 25 sets a mirror copying axis that is formed with the positions of the pixels located on the outer periphery of a boundary of the filtering range of the deblocking filter. Further, the loop filtering unit 25 changes the coefficient set so that the pixels having mirror copies thereof formed on taps within the filtering range are used.

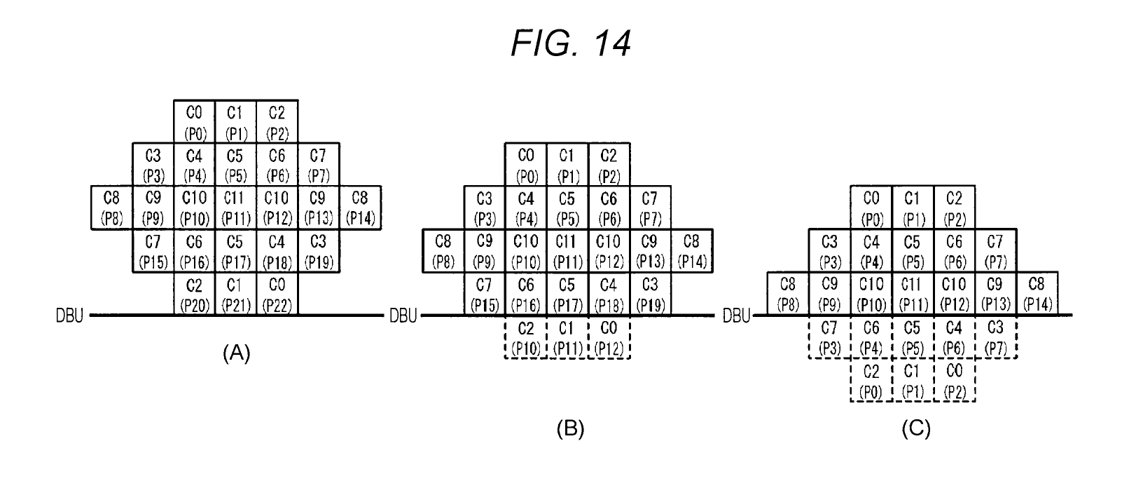

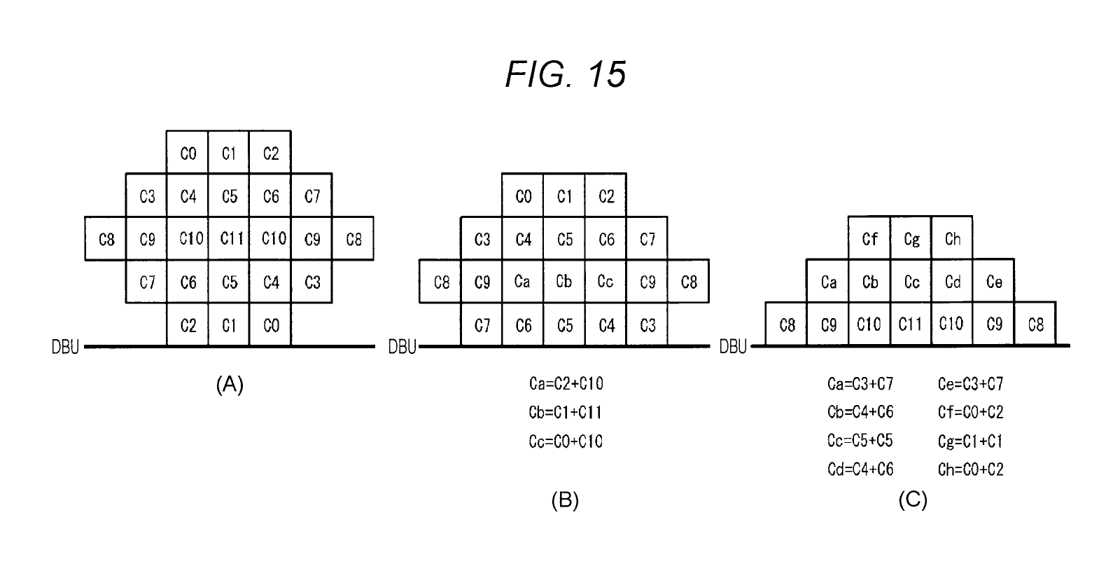

FIG. 14 shows examples of tap constructions for the deblocking filtering process, and FIG. 15 shows examples of coefficient set constructions for the deblocking filtering process. In FIGS. 14 and 15, “C0 through C11 and Ca through Ch” represent coefficients, and “P0 through P22” represent the image data of respective taps.

(A) of FIG. 14 shows a case where the current pixel being processed by the loop filter is located in such a line position that taps are not included in the filtering range of the deblocking filter. (B) and (C) of FIG. 14 each show a case where the current pixel is located in such a line position that taps are included in the filtering range of the deblocking filter. In the cases illustrated in (B) and (C) of FIG. 14, the loop filtering unit 25 sets a mirror copying axis that is formed with the positions of the pixels located on the outer periphery of a boundary of the filtering range of the deblocking filter. Further, the loop filtering unit 25 replaces the image data of taps located within the filtering range so that the pixels having mirror copies thereof formed on taps within the filtering range are used.

Specifically, as shown in (B) of FIG. 14, the image data P10 of a tap T10 is used as the image data of a tap T20 within the filtering range of the deblocking filter. Likewise, the image data P11 of a tap T11 is used as the image data of a tap T21 within the filtering range, and the image data P12 of a tap T12 is used as the image data of a tap T22.

Also, as shown in (C) of FIG. 14, the image data P3 of a tap T3 is used as the image data of a tap T15 within the filtering range of the deblocking filter. Likewise, the image data P4 of a tap T4 is used as the image data of a tap T16 within the filtering range, the image data P5 of a tap T5 is used as the image data of a tap T17, the image data P6 of a tap T6 is used as the image data of a tap T18, and the image data P7 of a tap T7 is used as the image data of a tap T19. Further, the image data P0 of a tap T0 is used as the image data of the tap T20 within the filtering range of the deblocking filter, the image data P1 of a tap T1 is used as the image data of the tap T21, and the image data P2 of a tap T2 is used as the image data of the tap T22.

(A) of FIG. 15 shows a case where the current pixel being processed by the loop filter is located in such a line position that taps are not included in the filtering range of the deblocking filter. (B) and (C) of FIG. 15 each show a case where the current pixel is located in such a line position that taps are included in the filtering range of the deblocking filter. In the cases illustrated in (B) and (C) of FIG. 15, the loop filtering unit 25 sets a mirror copying axis that is formed with the positions of the pixels located on the outer periphery of a boundary of the filtering range of the deblocking filter. Further, the loop filtering unit 25 changes the coefficient set so that the pixels having mirror copies thereof formed on taps within the filtering range are used.

Specifically, as shown in (B) of FIG. 15, the mirror copying axis is formed with the positions of the pixels located on the outer periphery of the boundary of the filtering range of the deblocking filter, and the coefficient of the tap T20 is added to the coefficient of the tap T10, which is located in a position symmetrical to the tap T20, to generate a coefficient Ca (=C2+C10). Likewise, the coefficient of the tap T21 is added to the coefficient of the tap T11 to generate a coefficient Cb (=C1+C11), and the coefficient of the tap T22 is added to the coefficient of the tap T1 to generate a coefficient Cc (=C0+C10). Meanwhile, the coefficients of the taps within the filtering range of the deblocking filter are set to “0”.

Also, as shown in (C) of FIG. 15, the mirror copying axis is formed with the positions of the pixels located on the outer periphery of the boundary of the filtering range of the deblocking filter, and the coefficient of the tap T15 is added to the coefficient of the tap T3, which is located in a position symmetrical to the tap T15, to generate a coefficient Ca (=C3+C7). Likewise, the coefficient of the tap T16 is added to the coefficient of the tap T4 to generate a coefficient Cb (=C4+C6), the coefficient of the tap T17 is added to the coefficient of the tap T5 to generate a coefficient Cc (=C5+C5), the coefficient of the tap T18 is added to the coefficient of the tap T6 to generate a coefficient Cd (=C4+C6), and the coefficient of the tap T19 is added to the coefficient of the tap T7 to generate a coefficient Ce (=C3+C7). Further, the coefficient of the tap T20 is added to the coefficient of the tap T0 to generate a coefficient Cf (=C0+C2), the coefficient of the tap T21 is added to the coefficient of the tap T1 to generate a coefficient Cg (=C1+C1), and the coefficient of the tap T22 is added to the coefficient of the tap T2 to generate a coefficient Cg (=C0+C2).

As described above, in a case where some of the taps are included in the filtering range of the deblocking filter, taps for the deblocking filtering process or a coefficient set for the deblocking filtering process is constructed. Accordingly, the loop filtering process can be performed without the use of image data subjected to the deblocking filtering process, and the memory capacity of the line memory can be reduced as in the first embodiment.

### <9. Third Embodiment of the Loop Filtering Unit>

### [Structure of the Loop Filtering Unit]

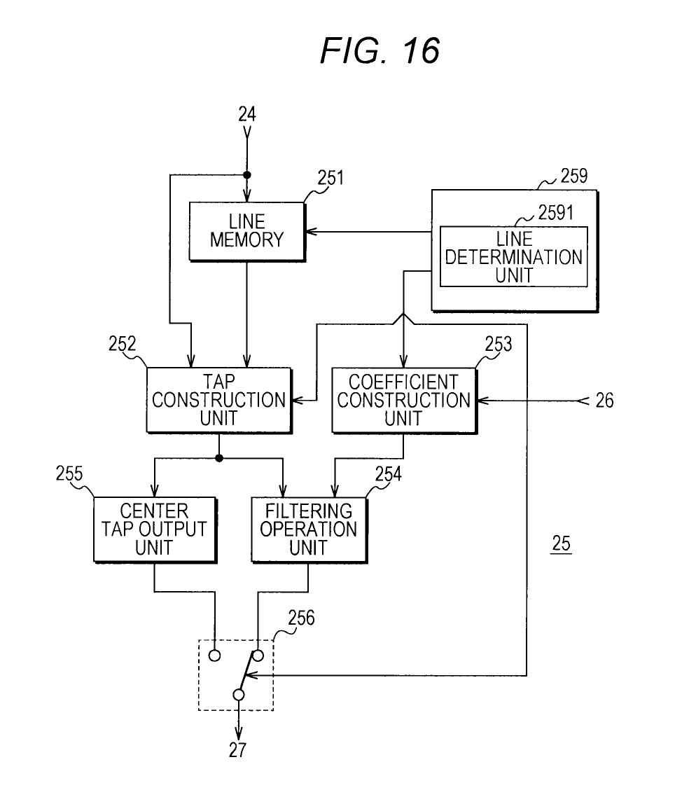

FIG. 16 shows the structure of a third embodiment of the loop filtering unit. The loop filtering unit 25 includes a line memory 251, a tap construction unit 252, a coefficient construction unit 253, a filtering operation unit 254, a center tap output unit 255, an output selection unit 256, and a filter control unit 259.

Image data that is output from the deblocking filtering unit 24 is supplied to the line memory 251 and the tap construction unit 252.

Based on a control signal from the filter control unit 259, the line memory 251 stores image data of a predetermined number of lines counted from the lower block boundary of the current block to be subjected to the loop filtering process. The line memory 251 also reads stored image data based on the control signal, and outputs the image data to the tap construction unit 252.

Using the image data supplied from the deblocking filtering unit 24 and the image data stored in the line memory 251, the tap construction unit 252 constructs taps based on the current pixel being processed by the loop filter. The tap construction unit 252 outputs the image data of the constructed taps to the filtering operation unit 254.

The coefficient construction unit 253 reads coefficients to be used in the filtering operation from the coefficient memory unit 26, determines the coefficients corresponding to the taps constructed by the tap construction unit 252, and constructs a coefficient set including the coefficients of the respective taps. The coefficient construction unit 253 outputs the constructed coefficient set to the filtering operation unit 254.

The filtering operation unit 254 performs an operation by using the image data of the taps supplied from the tap construction unit 252 and the coefficients supplied from the coefficient construction unit 253, to generate image data subjected to the loop filtering process.

The center tap output unit 255 outputs the image data of the center tap among the taps supplied from the tap construction unit 252, or the image data of the current pixel being processed by the loop filter, to the output selection unit 256.

The output selection unit 256 selects image data based on the control signal from the filter control unit 259, and outputs the selected image data from the filtering operation unit 254.

The filter control unit 259 supplies the control signal to the line memory 251, to control the storing of image data into the line memory 251 and the reading of stored image data. The filter control unit 259 includes a line determination unit 2591, and also controls the image data selecting operation of the output selection unit 256 in accordance with whether the tap positions are located within a predetermined range from the lower block boundary or within the filtering range of the deblocking filter, for example.

### [Operation of the Loop Filtering Unit]

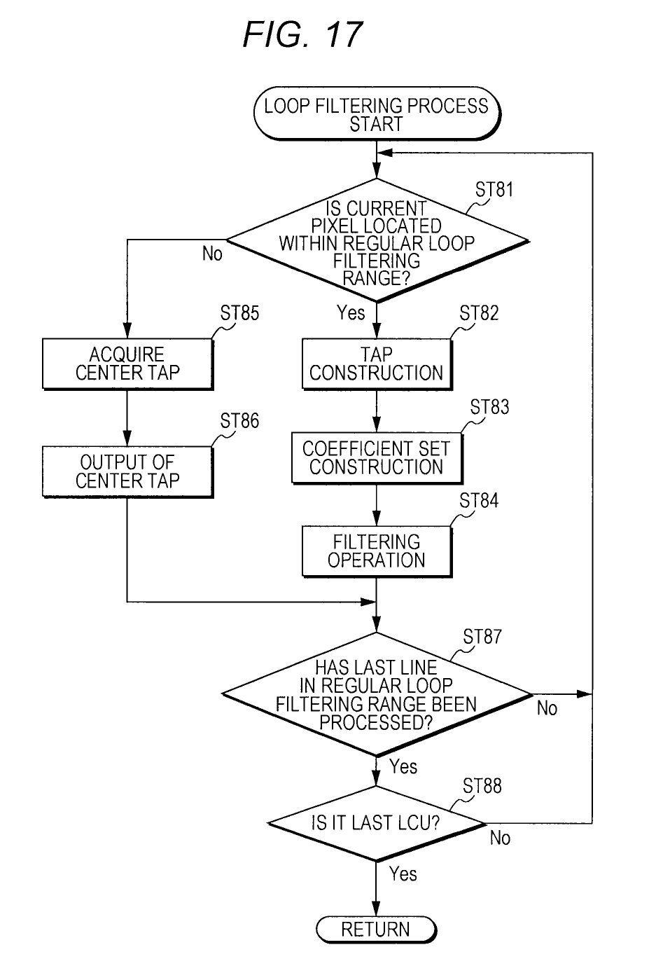

FIG. 17 is a flowchart showing an operation of the third embodiment of the loop filtering unit 25. In step ST81, the loop filtering unit 25 determines whether the current pixel is located within a regular loop filtering range. The loop filtering unit 25 determines whether the line position of the current pixel being processed by the loop filter is such a position that taps in the filtering range of the deblocking filter are not included. If taps are not included in the filtering range of the deblocking filter, the loop filtering unit 25 determines that the line position is located within the regular loop filtering range, and moves on to step ST82. If one or more taps are included in the filtering range of the deblocking filter, the loop filtering unit 25 determines that the line position is outside the regular loop filtering range, and moves on to step ST85.

In step ST82, the loop filtering unit 25 constructs taps. The loop filtering unit 25 constructs the taps based on the current pixel being processed by the loop filter, and moves on to step ST83.

In step ST83, the loop filtering unit 25 constructs a coefficient set. The loop filtering unit 25 reads coefficients from the coefficient memory unit 26, constructs the coefficient set formed with the coefficients for the taps, and then moves on to step ST84.

In step ST84, the loop filtering unit 25 performs a filtering operation. The loop filtering unit 25 performs the filtering operation by using the taps and the coefficient set constructed by the processing in steps ST82 and ST83, calculates the image data subjected to the loop filtering process for the current pixel, and then moves on to step ST87.

In step ST85, the loop filtering unit 25 acquires the center tap. The loop filtering unit 25 acquires the image data of the center tap, which is the current pixel being processed by the loop filter, and then moves on to step ST86.

In step ST86, the loop filtering unit 25 outputs the center tap. The loop filtering unit 25 outputs the image data of the center tap. Specifically, when the current pixel is not located within the regular loop filtering range, the loop filtering unit 25 outputs the image data without performing the loop filtering process, and then moves on to step ST87.

In step ST87, the loop filtering unit 25 determines whether the last line in the regular loop filtering range has been processed. If the last line in the regular loop filtering range in the LCU has not been subjected to the loop filtering process, for example, the loop filtering unit 25 returns to step ST81, and performs the loop filtering process on the next line position. If the last line has been subjected to the loop filtering process, the loop filtering unit 25 moves on to step ST88.

In step ST88, the loop filtering unit 25 determines whether the current LCU is the last LCU. If the current LCU subjected to the loop filtering process is not the last LCU, the loop filtering unit 25 returns to step ST81, and performs the loop filtering process on the next LCU. If the current LCU subjected to the loop filtering process is the last LCU, the loop filtering unit 25 ends the loop filtering process.

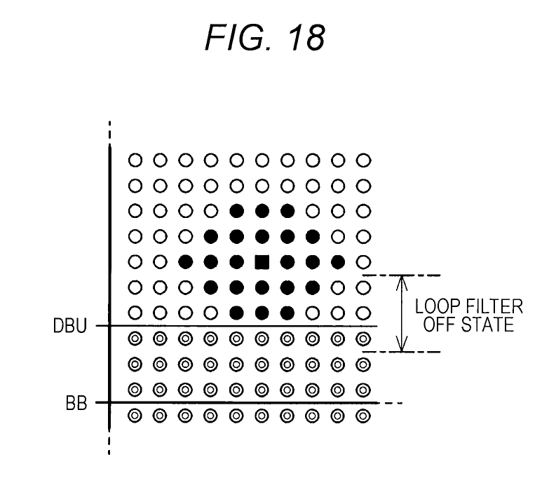

FIG. 18 shows a current pixel located in such a position that the loop filter is put into an off state. In a case where taps constructed for the current pixel being processed by the loop filter are located within the deblocking filtering range, the loop filtering process is put into an off state. In that case, there is no need to store image data so as to allow the loop filtering process with image data subjected to the deblocking filtering process, and accordingly, the line memory can be reduced.

### <10. Fourth Embodiment of the Loop Filtering Unit>

A fourth embodiment of the loop filtering unit selectively performs the operation of the third embodiment and the operation of the first or second embodiment. The fourth embodiment of the loop filtering unit has the same structure as the structure of the third embodiment shown in FIG. 16.

The filter control unit 259 performs control by supplying a control signal to the line memory 251, so as to store image data into the line memory 251 and read and supply stored image data to the tap construction unit 252. The filter control unit 259 includes a line determination unit 2591, and also controls operations of the tap construction unit 252, the coefficient construction unit 253, and the output selection unit 256 in accordance with the position of the current pixel being processed by the loop filter.

Based on encoding costs and the quantization parameter being used by the quantization unit 15, such as a quantization parameter that is set for each frame, the filter control unit 259 selects the operation of the above described first (second) embodiment or the operation of the third embodiment.

When using encoding costs, the filter control unit 259 compares the cost function value in the operation of the first (second) embodiment with the cost function value in the operation of the third embodiment, and selects the operation with the smaller cost function value.

When the quantization parameter is equal to or smaller than a threshold value, for example, the filter control unit 259 performs the operation of the third embodiment, since the quantization step is considered to be small, and high image quality is expected. When the quantization parameter is larger than the threshold value, the image data to be used for taps is replaced or the coefficient set is changed as in the first (second) embodiment, since image quality is supposedly lower than in a case where the quantization parameter is small.

Further, the filter control unit 259 in the loop filtering unit 25 of the image encoding device 10 incorporates selection information into an encoded stream so that the image decoding device 50 can perform the same loop filtering process as the loop filtering process of the image encoding device 10. The selection information indicates which process is selected, the process to output image data without performing a filtering operation (the operation of the third embodiment) or the process to replace the image data of taps or change the coefficient set (the operation of the first (second) embodiment). Based on the selection information contained in the encoded stream, the loop filtering unit 57 of the image decoding device 50 performs the same processes as those by the image encoding device 10.

To reduce the line memory in the loop filtering process, image data that has not been subjected to the deblocking filtering process may be used when taps for the loop filtering process are located in the filtering range of the deblocking filter, as suggested by Semih Esenlik, Matthias Narroschke, and Thomas Wedi (Panasonic R & D Center) in “JCTVC-E225 Line Memory Reduction for ALF Decoding, Joint Collaborative Team on Video Coding (JCT-VC) of ITU-T SG16 WP3 and ISO/IEC JTC1/SC29/WG11, 5th Meeting, Geneva, CH, 16-23 Mar., 2011”. By this method, however, the loop filtering process using image data subjected to the deblocking filtering process is performed when taps are not located within the filtering range of the deblocking filter. When taps are located within the filtering range of the deblocking filter, the loop filtering process is performed by using image data that has not been subjected to the deblocking filtering process, and the deblocking filtering process is then performed on the image data that has not been subjected to the deblocking filtering process. As described above, the deblocking filtering process and the loop filtering process have dependence on each other in terms of processing order, and therefore, the deblocking filtering process cannot be performed in parallel with the loop filtering process. In the present technique, however, the loop filtering process is performed by using image data subjected to the deblocking filtering process. Accordingly, processes are performed independently of one another, and no problems will be caused when the deblocking filtering process and the loop filtering process are performed in parallel in the screen.

### <11. Fifth Embodiment of the Loop Filtering Unit>

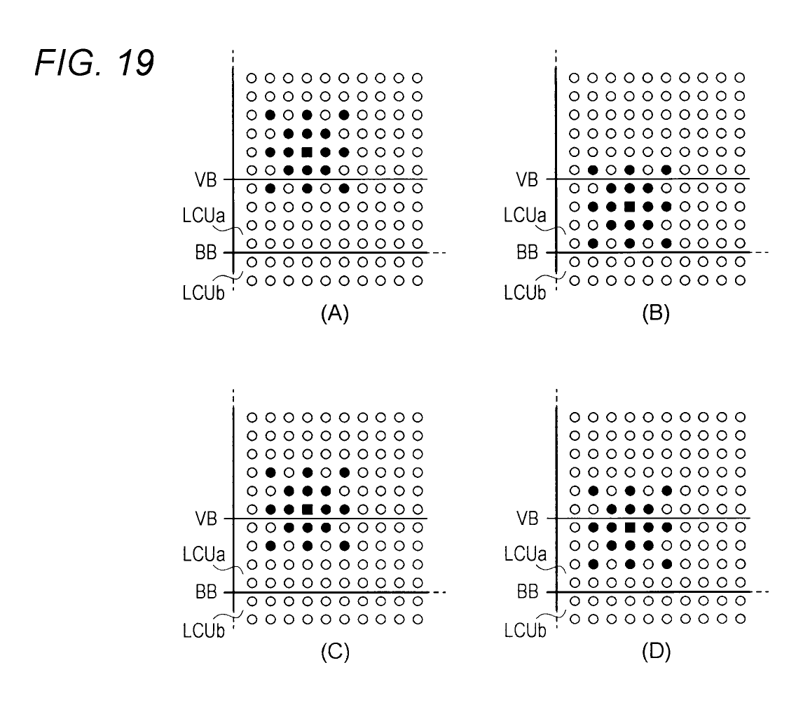

According to “JCTVC-G212 Non-CE8.c.7: Single-source SAO and ALF virtual boundary processing with cross 9×9”, Joint Collaborative Team on Video Coding (JCT-VC) of ITU-T SG16 WP3 and ISO/IEC JTC1/SC29/WG11 7th Meeting: Geneva, CH, 21-30 Nov., 2011”, averaging is performed on the pixels before and after filtering in a case where a virtual boundary VB is set as shown in FIG. 19 and one line is located outside the virtual boundary as shown in (A) of FIG. 19 and (B) of FIG. 19. In a case where two lines are located outside the virtual boundary as shown in (C) of FIG. 19 and (D) of FIG. 19, filtering is skipped. In FIG. 19, each current pixel is represented by a black square, and each tap is represented by a black circle. In such a process, however, pixels that has not been filtered are used when one line is located outside the virtual boundary, and therefore, the filtering effect becomes smaller. Any filtering effect is not achieved when two lines are located outside the virtual boundary. Therefore, high image quality with little noise cannot be achieved in the virtual boundary portion. In view of this, the fifth embodiment of the loop filtering unit relates to a process to achieve high image quality with little noise even in a boundary portion such as the virtual boundary portion.

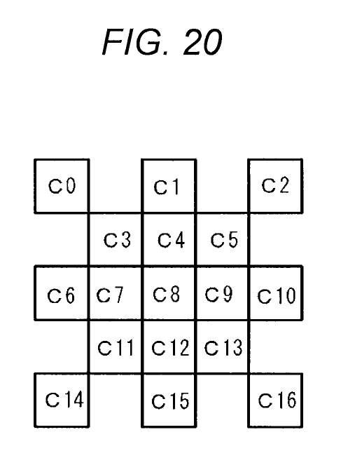

An operation of the fifth embodiment is described below. In the operation of the fifth embodiment, when the lower end line or the upper end line is located outside a boundary, the image data of the taps located outside the boundary is replaced or the coefficient set is changed so that a filtering operation can be performed without the use of the image data in the region located outside the boundary. Here, the filter (the taps of the filter) has an asterisk shape formed with 5×5 pixels, for example, as shown in FIG. 20.

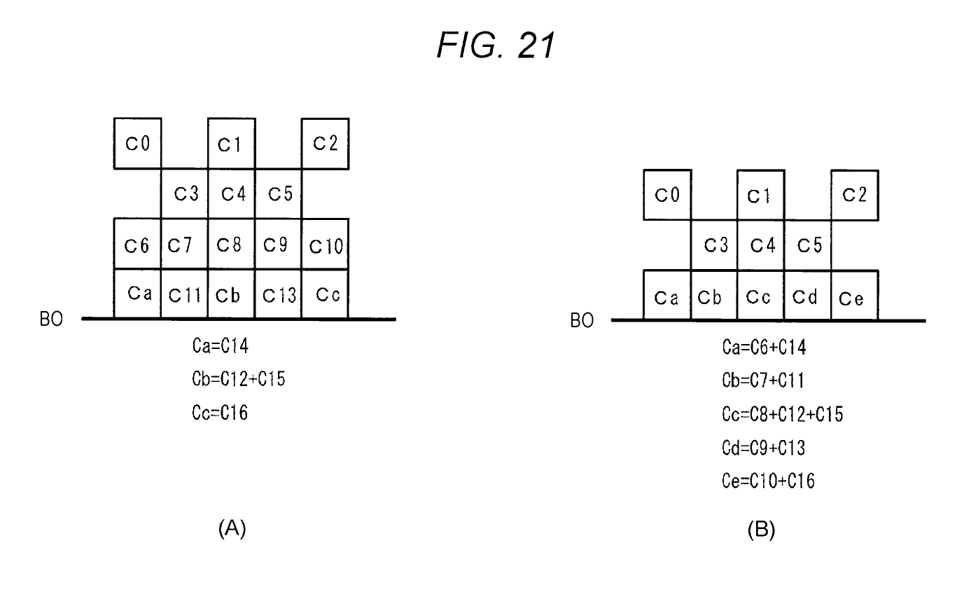

FIG. 21 is a diagram for explaining processes in cases where one or more lower end lines are located outside a boundary. (A) of FIG. 21 illustrates a case where one lower end line is located outside a boundary BO, and (B) of FIG. 21 illustrates a case where two lower end lines are located outside the boundary BO. When a lower end line is located outside the boundary, the filtering process is held off. After holding off the filtering process, the filtering process is performed by using the pixels of a line not located outside the boundary (a line located inside the boundary) as the pixels of the line(s) located outside the boundary.

When one lower end line is located outside the boundary, as shown in (A) of FIG. 21, the coefficients for the pixels of a line located inside the boundary to be used as the pixels of the line located outside the boundary BO are shown as coefficients Ca, Cb, and Cc. The coefficient Ca is “Ca=C14”. Specifically, in the filtering operation, the image data of the pixel having the coefficient Ca is used as the image data of the tap having the coefficient C14. The coefficient Cb is “Cb=C12+C15”. Specifically, in the filtering operation, the image data of the pixel having the coefficient Cb is used as the image data of the tap having the coefficient C15. The coefficient Cc is “Cc=C16”. In the filtering operation, the image data of the pixel having the coefficient Cc is used as the image data of the tap having the coefficient C16. In this manner, the filtering operation is performed without a change in filter size or filter shape, and without the use of the pixels of the line located outside the boundary. Further, when one lower end line is located outside the boundary, a filtered image is used, but averaging using pixels that have not been filtered is not performed.

When two lower end lines are located outside the boundary, as shown in (B) of FIG. 21, the coefficients for the pixels of a line located inside the boundary to be used as the pixels of the lines located outside the boundary BO are shown as coefficients Ca, Cb, Cc, Cd, and Ce. The coefficient Ca is “Ca=C6+C14”. The coefficient Cb is “Cb=C7+C11”. The coefficient Cc is “Cc=C8+C12+C15”. The coefficient Cd is “Cd=C9+C13”. The coefficient Ce is “Ce=C10+C16”. In this manner, when two lower end lines are located outside the boundary, the filtering operation is performed without a change in filter size or filter shape, and without the use of the pixels of the lines located outside the boundary, as in the case where one lower end line is located outside the boundary.

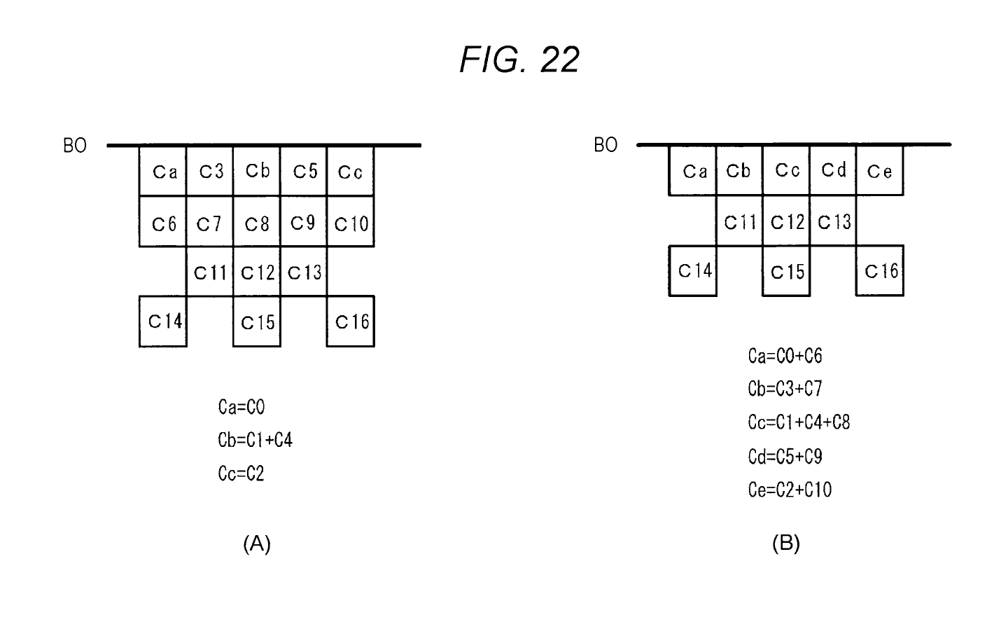

FIG. 22 is a diagram for explaining processes in cases where one or more upper end lines are located outside a boundary. (A) of FIG. 22 illustrates a case where one upper end line is located outside a boundary BO, and (B) of FIG. 22 illustrates a case where two upper end lines are located outside the boundary BO. When an upper end line is located outside the boundary, the filtering process is held off, as in a case where a lower end line is located outside a boundary.

When one upper end line is located outside the boundary, as shown in (A) of FIG. 22, the coefficients for the pixels of a line located inside the boundary to be used as the pixels of the line located outside the boundary BO are shown as coefficients Ca, Cb, and Cc. The coefficient Ca is “Ca=C0”. The coefficient Cb is “Cb=C1+C4”. The coefficient Cc is “Cc=C2”. In this manner, when one upper end line is located outside the boundary, the filtering operation is performed without a change in filter size or filter shape, and without the use of the pixels of the line located outside the boundary, as in a case where one lower end line is located outside the boundary. Further, when one upper end line is located outside the boundary, a filtered image is used, but averaging using pixels that have not been filtered is not performed.

When two upper end lines are located outside the boundary, as shown in (B) of FIG. 22, the coefficients for the pixels of a line located inside the boundary to be used as the pixels of the lines located outside the boundary BO are shown as coefficients Ca, Cb, Cc, Cd, and Ce. The coefficient Ca is “Ca=C0+C6”. The coefficient Cb is “Cb=C3+C7”. The coefficient Cc is “Cc=C1+C4+C8”. The coefficient Cd is “Cd=C5+C9”. The coefficient Ce is “Ce=C2+C10”. In this manner, when two upper end lines are located outside the boundary, the filtering operation is performed without a change in filter size or filter shape, and without the use of the pixels of the lines located outside the boundary, as in a case where one upper end line is located outside the boundary.

Also, the filtering operation may be performed by using the coefficients Ca through Ce as the coefficients of the filter, with the taps being the pixels in the positions of the coefficients Ca through Ce shown in FIGS. 21 and 22.

Further, when a lower end line or an upper end line is located outside a boundary, a change may be made to filter size or filter shape, so that the filtering operation can be performed without the use of the image data in the region outside the boundary. Also, when filter size and filter shape are changed, weighting may be performed.

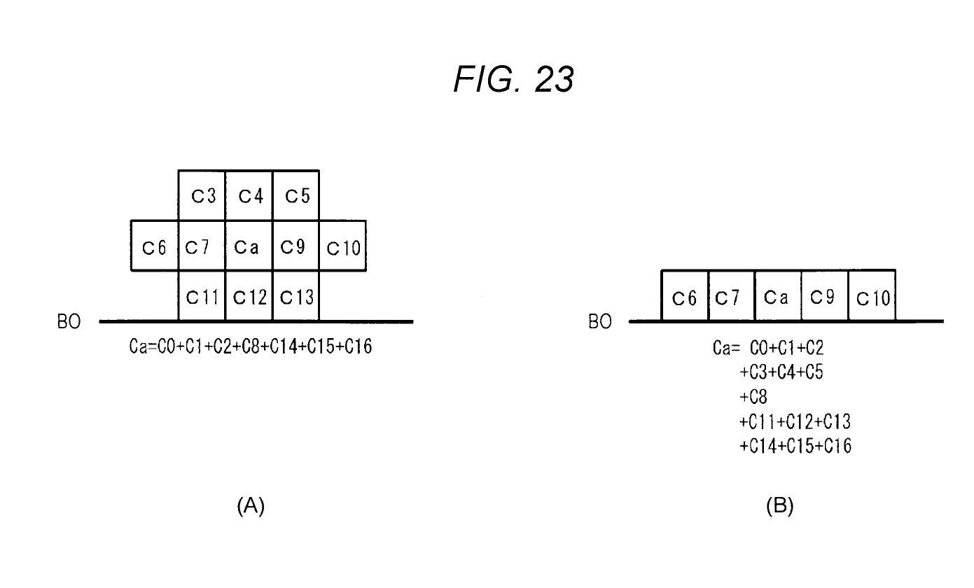

FIG. 23 is a diagram for explaining processes to change filter size and filter shape in cases where one or more lower end lines are located outside a boundary. (A) of FIG. 23 illustrates a case where one lower end line is located outside a boundary BO, and (B) of FIG. 23 illustrates a case where two lower end lines are located outside the boundary BO.

When one lower end line is located outside the boundary, filter size and filter shape are changed so that the pixels of the line located outside the boundary are not used. For example, each one line is deleted from the top and the bottom of the filter shown in FIG. 20, and a “5 (width)×3 (height)” filter shown in (A) of FIG. 23 is formed. When weighting is performed, a coefficient that is no longer used in the filtering operation is added to the center tap, for example. Specifically, the coefficient Ca of the center tap is “Ca=C0+C1+C2+C8+C14+C15+C16”. When one lower end line is located outside the boundary, a filtered image is used, but averaging using pixels that have not been filtered is not performed as described above.

When two lower end lines are located outside the boundary, filter size and filter shape are changed so that the pixels of the lines located outside the boundary are not used. For example, each two lines are deleted from the top and the bottom of the filter shown in FIG. 20, and a “5 (width)×1 (height)” filter shown in (B) of FIG. 23 is formed. When weighting is performed, a coefficient that is no longer used in the filtering operation is added to the center tap, for example. Specifically, the coefficient Ca of the center tap is “Ca=C0+C1+C2+C3+C4+C5+C8+C11+C12+C13+C14+C15+C16”.

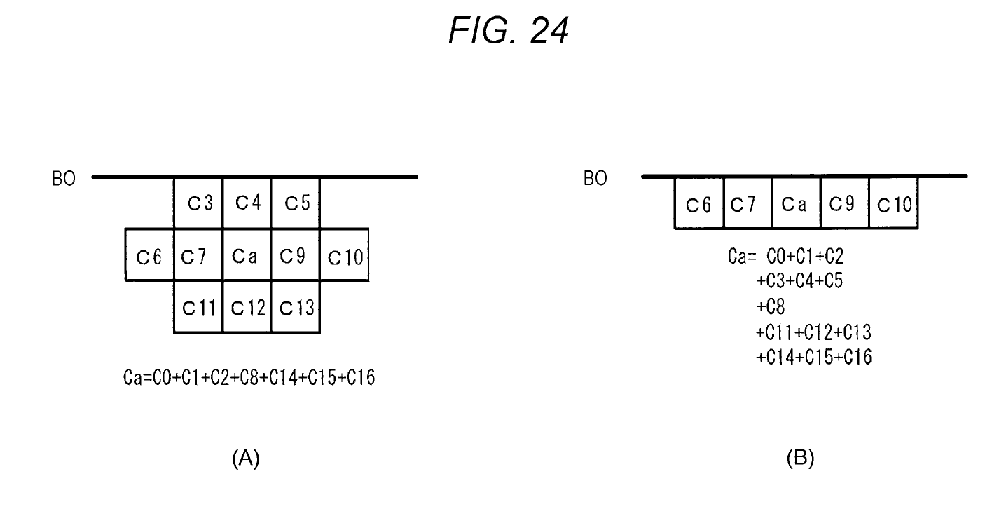

FIG. 24 is a diagram for explaining processes to change filter size and filter shape in cases where one or more upper end lines are located outside a boundary. (A) of FIG. 24 illustrates a case where one upper end line is located outside a boundary BO, and (B) of FIG. 24 illustrates a case where two upper end lines are located outside the boundary BO.

When one upper end line is located outside the boundary, filter size and filter shape are changed so that the pixels of the line located outside the boundary are not used. For example, each one line is deleted from the top and the bottom of the filter shown in FIG. 20, and a “5 (width)×3 (height)” filter shown in (A) of FIG. 24 is formed. When weighting is performed, a coefficient that is no longer used in the filtering operation is added to the center tap, for example. Specifically, the coefficient Ca of the center tap is “Ca=C0+C1+C2+C8+C14+C15+C16”. When one upper end line is located outside the boundary, a filtered image is used, but averaging using pixels that have not been filtered is not performed as described above.

When two upper end lines are located outside the boundary, filter size and filter shape are changed so that the pixels of the lines located outside the boundary are not used. For example, each two lines are deleted from the top and the bottom of the filter shown in FIG. 20, and a “5 (width)×1 (height)” filter shown in (B) of FIG. 24 is formed. When weighting is performed, a coefficient that is no longer used in the filtering operation is added to the center tap, for example. Specifically, the coefficient Ca of the center tap is “Ca=C0+C1+C2+C3+C4+C5+C8+C11+C12+C13+C14+C15+C16”.

As described above, in the fifth embodiment, when one lower end line or one upper end line is located outside a boundary, averaging is not performed by using pixels that have not been filtered and pixels that have been filtered. Accordingly, a decrease in filtering effect can be prevented. Also, even when two lower end lines or two upper end lines are located outside a boundary, the filtering process is performed, and accordingly, a filtering effect can be achieved. Thus, an image with little noise can be obtained even in a boundary portion.

<12. Another Structure and Operation in a Case where the Present Technique is Applied to an Image Encoding Device>

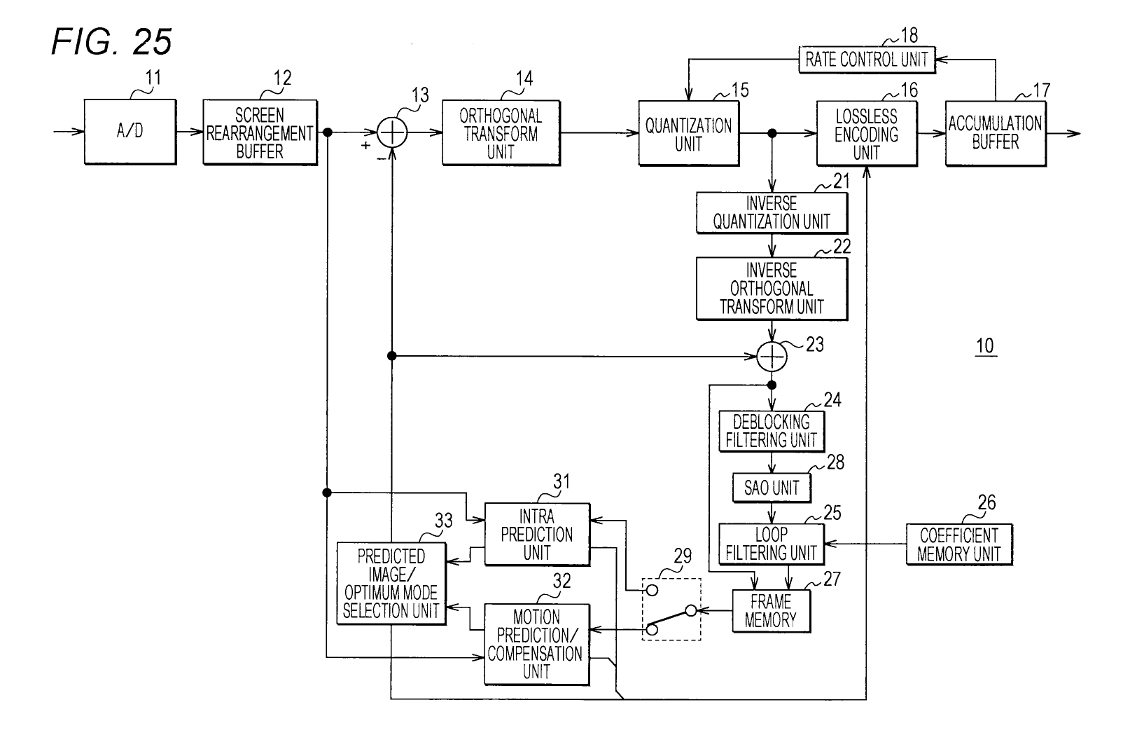

FIG. 25 shows another structure in a case where an image processing device of the present technique is applied to an image encoding device. In FIG. 25, the blocks equivalent to those shown in FIG. 2 are denoted by the same reference numerals as those used in FIG. 2.

In the image encoding device 10 shown in FIG. 25, an SAO (Sample Adaptive Offset) unit 28 is provided between the deblocking filtering unit 24 and the loop filtering unit 25, and the loop filtering unit 25 performs a loop filtering process on image data that has been subjected to an adaptive offset process (hereinafter referred to as the “SAO process”) by the SAO unit 28. It should be noted that SAO is equivalent to the above described PQAO (Picture Quality Adaptive Offset). The SAO unit 28 supplies information about the SAO process to the lossless encoding unit 16, to incorporate the information into an encoded stream.

The operation of the SAO unit 28 is now described. Offset types at the SAO unit 28 include two types called band offsets, and six types called edge offsets. Further, any offset may not be used. An image is divided in a quad-tree, and one or more of the above mentioned offset types can be selected for encoding in each of the regions.

The selection information is encoded by the lossless encoding unit 16 and is included in a bit stream. By using this method, encoding efficiency is increased.

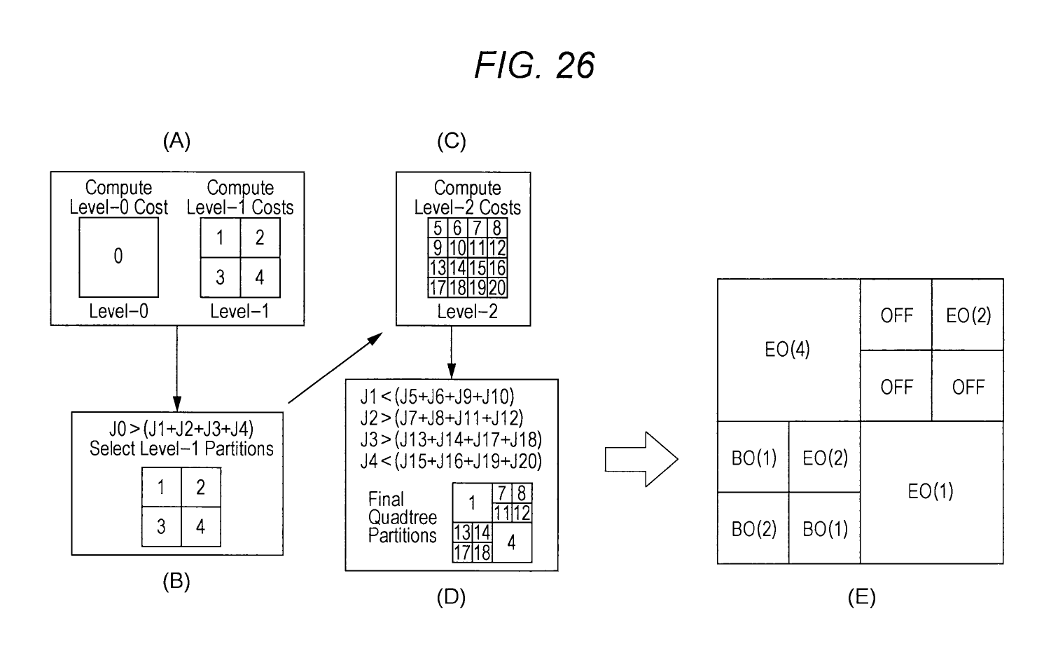

Referring now to FIG. 26, a quad-tree structure is described. For example, in the image encoding device 10, a cost function value J0 of Level-0 (division depth 0) indicating that a region 0 is not divided is calculated, as shown in (A) of FIG. 26. Also, cost function values J1, J2, J3, and J4 of Level-1 (division depth 0) indicating that the region 0 is divided into four regions 1 through 4 are calculated.

The cost function values are then compared, and the divisional regions (partitions) of Level-1, which has the smaller cost function value, are selected, since J0>(J1+J2+J3+J4), as shown in (B) of FIG. 26.

Likewise, cost function values J5 through J20 of Level-2 (division depth 2) indicating that the region 0 is divided into 16 regions 5 through 20 are calculated, as shown in (C) of FIG. 26.

The cost function values are then compared, and the divisional region (partition) of Level-1 is selected in the region 1, since J1<(J5+J6+J9+J10), as shown in (D) of FIG. 26. In the region 2, the divisional regions (partitions) of Level-2 are selected, since J2>(J7+J8+J11+J12). In the region 3, the divisional regions (partitions) of Level-2 are selected, since J3>(J13+J14+J17+J18). In the region 4, the divisional region (partition) of Level-1 is selected, since J4<(J15+J16+J19+J20).

As a result, ultimate quad-tree regions (partitions) shown in (D) of FIG. 26 are determined in the quad-tree structure. In each of the regions determined in the quad-tree structure, cost function values with respect to the two types of band offsets, the six types of edge offsets, and “no offset” are calculated, and which offsets are to be used in encoding is determined.

For example, as shown in (E) of FIG. 26, EO(4), which indicates four of the edge offset types, is determined in the region 1. In the region 7, OFF or “no offset” is determined. In the region 8, EO(2), which indicates two of the edge offset types, is determined. In the regions 11 and 12, OFF or “no offset” is determined.

In the region 13, BO(1), which indicates one of the band offset types, is determined. In the region 14, EO(2), which indicates two of the edge offset types, is determined. In the region 17, BO(2), which indicates two of the band offset types, is determined. In the region 18, BO(1), which indicates one of the band offset types, is determined. In the region 4, EO(1), which indicates one of the edge offset types, is determined.

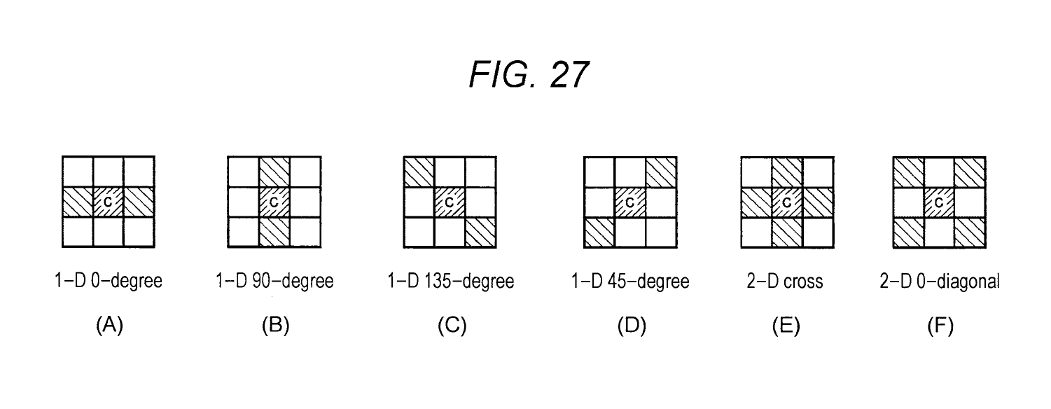

Referring now to FIG. 27, edge offsets are described in detail. In an edge offset, the current pixel value is compared with neighboring pixel values adjacent to the current pixel value, and an offset value is transmitted in accordance with the corresponding category.

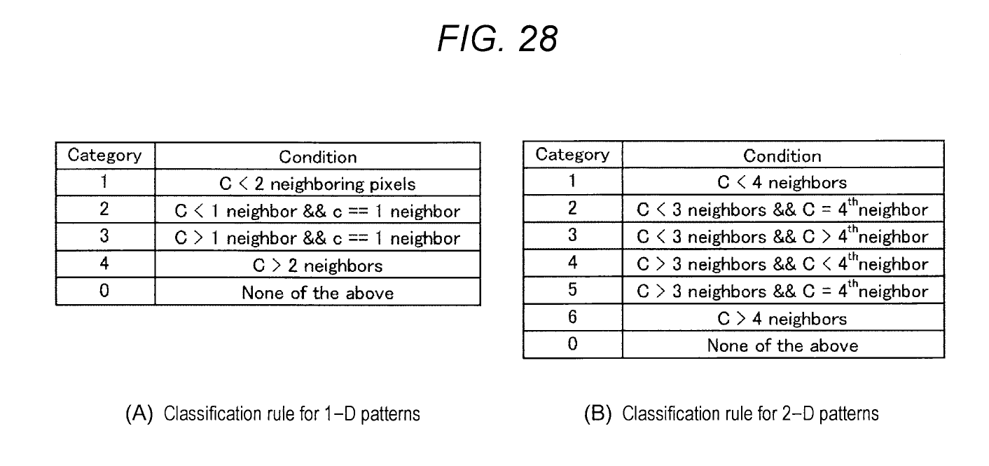

Edge offsets are classified into four one-dimensional patterns shown in (A) through (D) of FIG. 27, and two two-dimensional patterns shown in (E) and (F) of FIG. 27. Offsets are transmitted in accordance with categories shown in FIG. 28.

(A) of FIG. 27 shows a 1-D, 0-degree pattern in which the neighboring pixels are one-dimensionally located on the right and left sides of the current pixel C, or form a 0-degree angle with the pattern shown in (A) of FIG. 27. (B) of FIG. 27 shows a 1-D, 90-degree pattern in which the neighboring pixels are one-dimensionally located on the upper and lower sides of the current pixel C, or form a 90-degree angle with the pattern shown in (A) of FIG. 27.

(C) of FIG. 27 shows a 1-D, 135-degree pattern in which the neighboring pixels are one-dimensionally located on the upper left and lower right sides of the current pixel C, or form a 135-degree angle with the pattern shown in (A) of FIG. 27. (D) of FIG. 27 shows a 1-D, 135-degree pattern in which the neighboring pixels are one-dimensionally located on the upper right and lower left sides of the current pixel C, or form a 45-degree angle with the pattern shown in (A) of FIG. 27.

(E) of FIG. 27 shows a 2-D, cross pattern in which the neighboring pixels are two-dimensionally located on the right and left sides and on the upper and lower sides of the current pixel C, or cross at the current pixel C. (F) of FIG. 27 shows a 2-D, diagonal pattern in which the neighboring pixels are two-dimensionally located on the upper right and lower left sides and on the upper left and lower right sides of the current pixel C, or diagonally cross at the current pixel C.

(A) of FIG. 28 shows a list of rules for one-dimensional patterns (Classification rule for 1-D patterns). The patterns shown in (A) through (D) of FIG. 27 are classified under five categories shown in (A) of FIG. 28, and offsets are calculated in accordance with the categories and are sent to the decoding unit.

When the pixel value of the current pixel C is smaller than the pixel values of the two neighboring pixels, the pattern is classified as Category 1. When the pixel value of the current pixel C is smaller than the pixel value of one of the neighboring pixels and is equal to the pixel value of the other one of the neighboring pixels, the pattern is classified as Category 2. When the pixel value of the current pixel C is larger than the pixel value of one of the neighboring pixels and is equal to the pixel value of the other one of the neighboring pixels, the pattern is classified as Category 3. When the pixel value of the current pixel C is larger than the pixel values of the two neighboring pixels, the pattern is classified as Category 4. A pattern that does not fall in any of the above categories is classified as Category 0.

(B) of FIG. 28 shows a list of rules for two-dimensional patterns (Classification rule for 2-D patterns). The patterns shown in (E) and (F) of FIG. 27 are classified under seven categories shown in (B) of FIG. 28, and offsets are calculated in accordance with the categories and are sent to the decoding unit.

When the pixel value of the current pixel C is smaller than the pixel values of the four neighboring pixels, the pattern is classified as Category 1. When the pixel value of the current pixel C is smaller than the pixel values of three of the neighboring pixels and is equal to the pixel value of the fourth one of the neighboring pixels, the pattern is classified as Category 2. When the pixel value of the current pixel C is smaller than the pixel values of three of the neighboring pixels and is larger than the pixel value of the fourth one of the neighboring pixels, the pattern is classified as Category 3.

When the pixel value of the current pixel C is larger than the pixel values of three of the neighboring pixels and is smaller than the pixel value of the fourth one of the neighboring pixels, the pattern is classified as Category 4. When the pixel value of the current pixel C is larger than the pixel values of three of the neighboring pixels and is equal to the pixel value of the fourth one of the neighboring pixels, the pattern is classified as Category 5. When the pixel value of the current pixel C is larger than the pixel values of the four neighboring pixels, the pattern is classified as Category 6. A pattern that does not fall in any of the above categories is classified as Category 0.

As described above, in an edge offset, a 3×3 pixel determination process is performed. Therefore, the SAO unit 28 cannot perform an offset process when the pixel positions include the current pixel being processed by the deblocking filter in the determination process. Also, when a filtering process is performed by the deblocking filter thereafter, the SAO unit 28 performs a determination process by using pixels subjected to the deblocking filtering process. Therefore, the SAO unit 28 needs to store processed image data. Further, the loop filtering unit 25 cannot perform a loop filtering process when taps for the loop filtering process are located in pixel positions in which processing has not been performed by the SAO. When processing is performed by the SAO thereafter, the loop filtering unit 25 performs a loop filtering process by using pixels processed by the SAO 28. Therefore, the loop filtering unit 25 needs to store image data processed by the SAO unit 28.

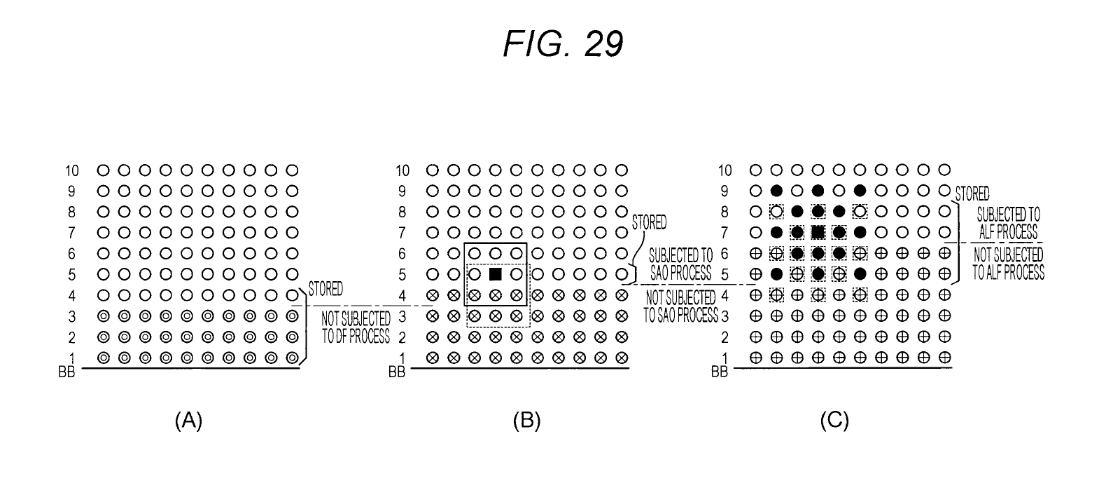

FIG. 29 shows relationships among image data stored in the line memory to perform a filtering process at the deblocking filtering unit 24, image data stored in the line memory to perform a process at the SAO unit 28, and image data stored in the line memory to perform a loop filtering process at the loop filtering unit 25. FIG. 29 illustrates example cases where image data is luminance data (Luma data).

When filtered image data of three lines counted from a block boundary is generated by using the image data of four lines, for example, the deblocking filtering unit 24 needs to store the image data of four lines counted from the lower block boundary BB, as shown in (A) of FIG. 29. In (A) of FIG. 29, double circles represent pixels that are to be processed by the deblocking filter and have not been subjected to a deblocking filtering process (DF process).

The SAO unit 28 cannot perform processing in a pixel position that includes a pixel being processed by the deblocking filter in a determination process. That is, processing can be performed in positions on the fifth line from the lower block boundary BB, as shown in (B) of FIG. 29. In positions on the fourth line, however, processing cannot be performed, since pixels being processed by the deblocking filter are included in the range of the 3×3 pixel determination process. Therefore, after the deblocking filtering process, the image data of the fifth line processed by the SAO unit 28 needs to be stored into the line memory so that processing can be performed in the positions on the remaining lines starting from the fourth line from the lower block boundary BB. In (B) of FIG. 29, the pixels represented by circles each having a x-mark therein are pixels on which an SAO process cannot be performed, since a deblocking filtering process has not been performed on those pixels.

In a case where taps are 5×5 pixels, for example, the loop filtering unit 25 cannot perform processing in a pixel position that includes a pixel that has not been processed by the SAO unit 28 in the taps. Specifically, as shown in (C) of FIG. 29, processing can be performed on the seventh line from the lower block boundary BB, but processing cannot be performed in positions on the sixth line, since the 5×5 pixel tap range includes pixels that have not been processed by the SAO unit 28. Therefore, after the deblocking filtering process, the image data of the four lines of the fifth through eighth lines from the lower block boundary, which have been processed by the SAO unit 28, needs to be stored into the line memory so that processing can be performed on the remaining lines starting from the sixth line. In (C) of FIG. 29, the pixels represented by circles each having a +-mark therein are pixels on which a loop filtering process (ALF) cannot be performed, since the deblocking filtering process has not been performed and therefore, image data subjected to the SAO process is not input.

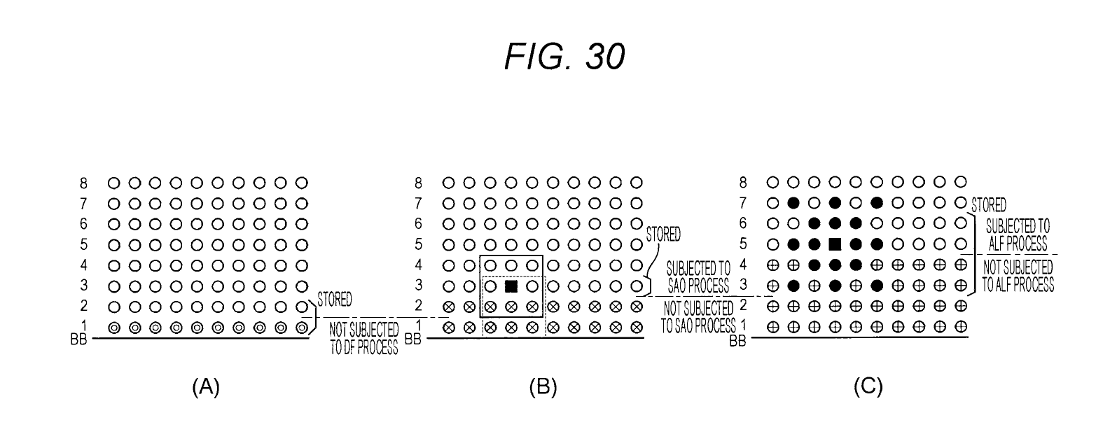

That is, the deblocking filtering unit 24, the SAO unit 28, and the loop filtering unit 25 need to store the image data of a total of nine lines for luminance data. As shown in FIG. 30, as for chrominance data (Chroma data), the deblocking filtering unit 24 stores the image data of two lines as shown in (A) of FIG. 30. As a result, it is necessary to store the image data of a total of seven lines including the image data to be stored for the processing to be performed by the SAO unit 28 shown in (B) of FIG. 30 and the processing to be performed by the loop filtering unit 25 shown in (C) of FIG. 30.

Therefore, when a tap position is located within a predetermined range from the lower block boundary BB, the loop filtering unit 25 changes the coefficient set so that a filtering operation can be performed without the use of image data within the predetermined range, and reduces the pixels to be used in the filtering operation. That is, the loop filtering process is performed with a reduced number of taps.

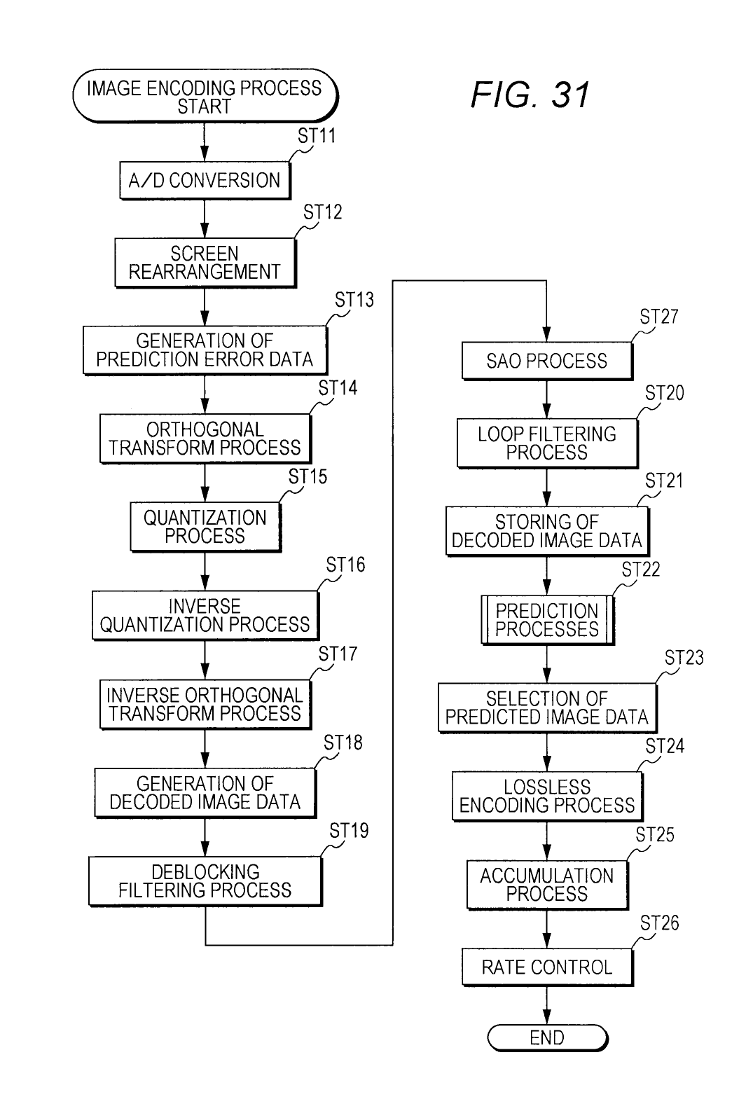

FIG. 31 is a flowchart showing an operation of another structure in the case where the present technique is applied to an image encoding device. In FIG. 31, the procedures equivalent to those shown in FIG. 3 are denoted by the same reference numerals as those used in FIG. 3. In FIG. 31, a SAO process is performed in step ST27 between the deblocking filtering process in step ST19 and the loop filtering process in step ST20. In the SAO process, an adaptive offset process is performed in the same manner as the SAO unit 28.

<13. Another Structure and Operation in a Case where the Present Technique is Applied to an Image Decoding Device>

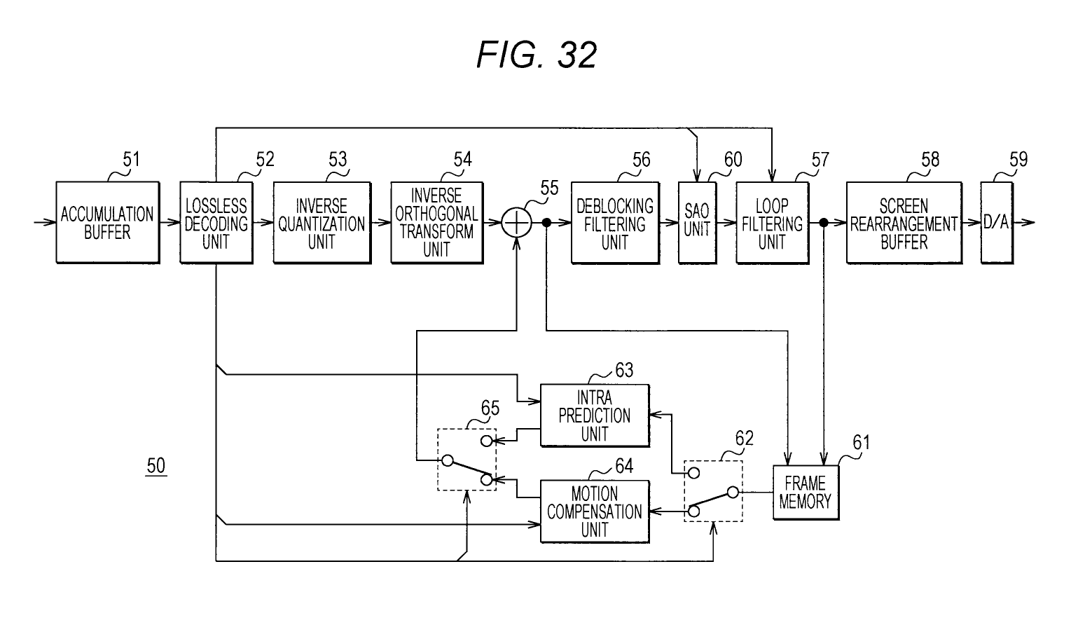

FIG. 32 shows another structure in a case where an image processing device of the present technique is applied to an image decoding device. In FIG. 32, the blocks equivalent to those shown in FIG. 6 are denoted by the same reference numerals as those used in FIG. 6.

In the image decoding device 50 shown in FIG. 32, an SAO unit 60 is provided between the deblocking filtering unit 56 and the loop filtering unit 57. The loop filtering unit 57 performs a loop filtering process on image data that has been subjected to an adaptive offset process by the SAO unit 60. Based on information about the SAO process included in an encoded stream, the SAO unit 60 performs the same process as that performed by the SAO unit 28 of the image encoding device 10.

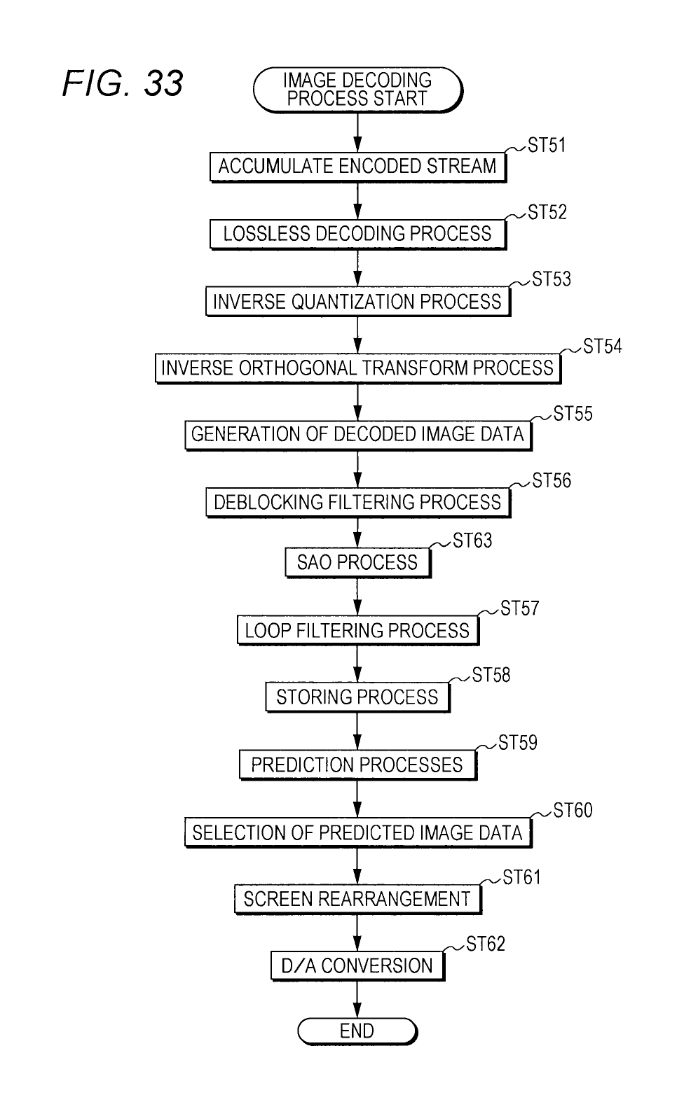

FIG. 33 is a flowchart showing the operation of another structure in the case where the present technique is applied to an image decoding device. In FIG. 33, the procedures equivalent to those shown in FIG. 7 are denoted by the same reference numerals as those used in FIG. 7.

In FIG. 33, a SAO process is performed in step ST63 between the deblocking filtering process in step ST56 and the loop filtering process in step ST57. In the SAO process, an adaptive offset process is performed in the same manner as the SAO unit 28.

### <14. Sixth Embodiment of the Loop Filtering Unit>

An operation of a sixth embodiment of the loop filtering unit is described below. In the sixth embodiment of the loop filtering unit, the number of taps is reduced in a loop filtering process when the current pixel is located outside a regular loop filtering range.

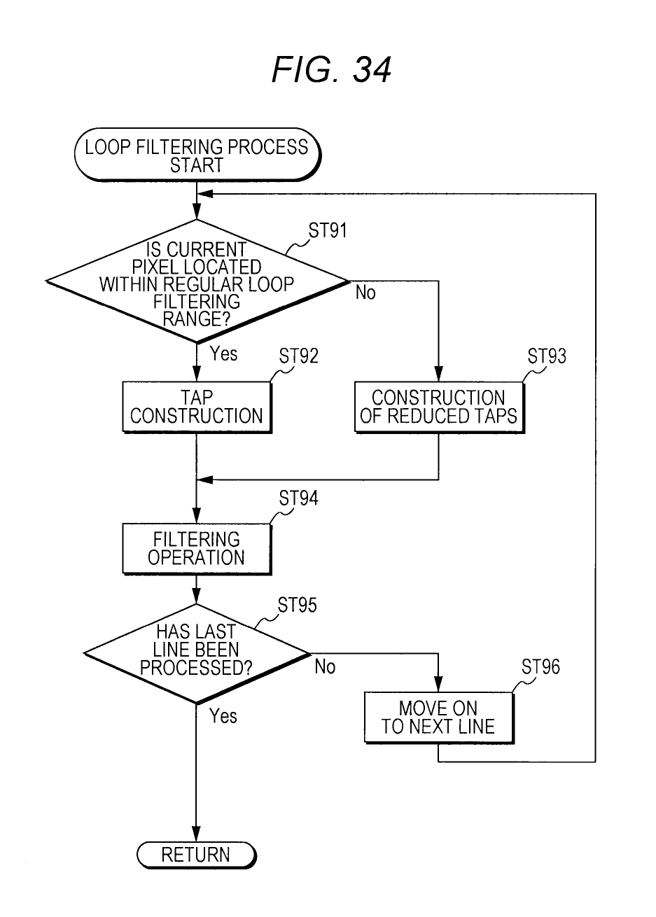

FIG. 34 is a flowchart showing a process in which the number of taps is reduced. In step ST91, the loop filtering unit 25 determines whether the current pixel is located within the regular loop filtering range. The loop filtering unit 25 determines whether the line position of the current pixel being processed by the loop filter is such a position that pixels not subjected to the processing by the SAO unit 28 are not included as taps. If the line position is such a position that pixels not subjected to the processing by the SAO unit 28 are not included as taps, the loop filtering unit 25 determines that the line position is located within the regular loop filtering range, and moves on to step ST92. If the line position is such a position that pixels not subjected to the processing by the SAO unit 28 are included as taps, the loop filtering unit 25 determines that the line position is outside the regular loop filtering range, and moves on to step ST93.

In step ST92, the loop filtering unit 25 constructs taps. Since pixels not subjected to the processing by the SAO unit 28 are not included as taps, the loop filtering unit 25 sets a predetermined number of taps, such as 5×5 pixel taps, and then moves on to step ST94.

In step ST93, the loop filtering unit 25 constructs a reduced number of taps. The loop filtering unit 25 reduces the number of taps so that the pixels not subjected to the processing by the SAO unit 28 are not used as taps. For example, the coefficient set is changed so that the image data of taps using pixels not subjected to the processing by the SAO unit 28, and 3×3 pixels are set as taps. The operation then moves on to step ST94.

In step ST94, the loop filtering unit 25 performs a filtering operation. The loop filtering unit 25 performs the filtering operation by using the taps constructed by the processing in step ST92 or step ST93, and calculates the image data subjected to the loop filtering process for the current pixel.

In step ST95, the loop filtering unit 25 determines whether the last line has been processed. The loop filtering unit 25 determines whether the loop filtering process has been performed on the last line among the lines subjected to the processing by the SAO unit 28. If the process has not been performed on the last line, the loop filtering unit 25 moves on to step ST96. If the loop filtering process has been performed on the last line, the loop filtering unit 25 ends the processing of the block until a block in a lower stage is processed, and the next line is processed by the SAO unit 28.

In step ST96, the loop filtering unit 25 moves the line of the current pixel to the next line, and returns to step ST91.

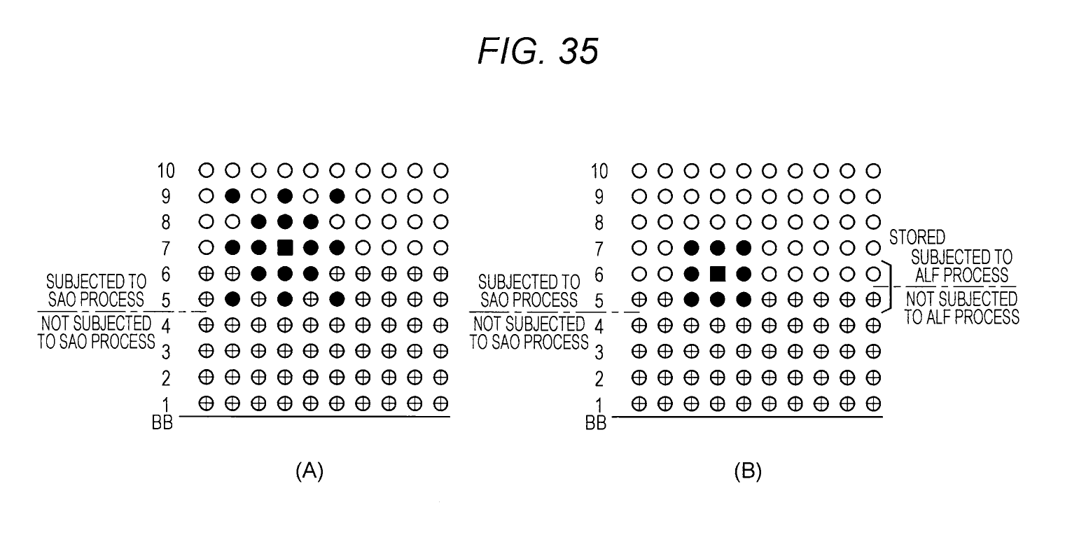

FIG. 35 illustrates an operation of the loop filtering unit 25. As shown in (A) of FIG. 35, the loop filtering unit 25 determines that the SAO process has not been performed on the first through fourth lines from the lower block boundary BB, and has been performed on the fifth line and the lines above the fifth line. Therefore, in a case where predetermined taps are taps of 5×5 pixels, the loop filtering unit 25 performs a loop filtering process on the first through seventh lines from the lower block boundary BB.

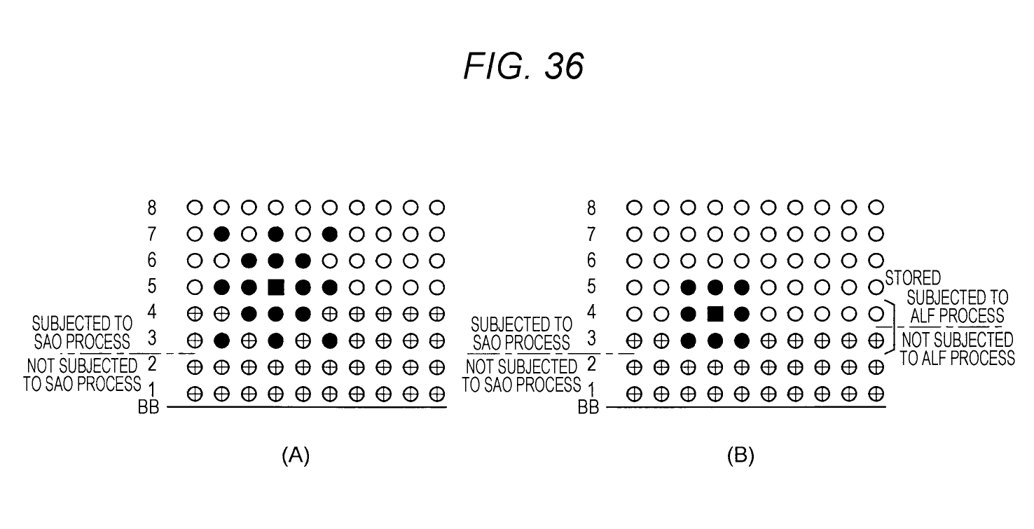

The loop filtering unit 25 then performs filtering on a predetermined number of taps in a position on the sixth line from the lower block boundary BB, and in doing so, requires pixels that have not been processed by the SAO unit 28 (pixels on the fourth line from the lower block boundary). Therefore, the loop filtering unit 25 reduces the number of taps so that the loop filtering process can be performed without the use of pixels that have not been processed by the SAO unit 28. For example, the number of taps is reduced to 3×3 pixels, as shown in (B) of FIG. 35. In this manner, the loop filtering process can proceed to a position on the sixth line from the lower block boundary BB. Also, as the number of taps is reduced in this manner, the image data of two lines that have been subjected to the processing by the SAO unit 28 and are the fifth and sixth lines from the lower block boundary BB should be stored so as to perform the loop filtering process in a position on the fifth line from the lower block boundary BB. That is, in a case where the tap position is located within a predetermined range from the lower block boundary BB, the line memory to store image data can be made smaller by reducing the number of taps. Also, the coefficient set may be changed so as to reduce the number of taps. In this manner, the number of taps can be reduced without a change in hardware configuration. FIG. 36 illustrates an operation of the loop filtering unit 25 for chrominance data. (A) of FIG. 36 shows a case where the number of taps is not reduced, and (B) of FIG. 36 shows a case where the number of taps is reduced.

Furthermore, the loop filtering unit 25 does not perform the loop filtering process on the line that is processed immediately before the line on which the processing by the SAO unit 28 is stopped because the line has not been subjected to the deblocking filtering process. In this manner, one more line can be added to the lines subjected to the loop filtering process.

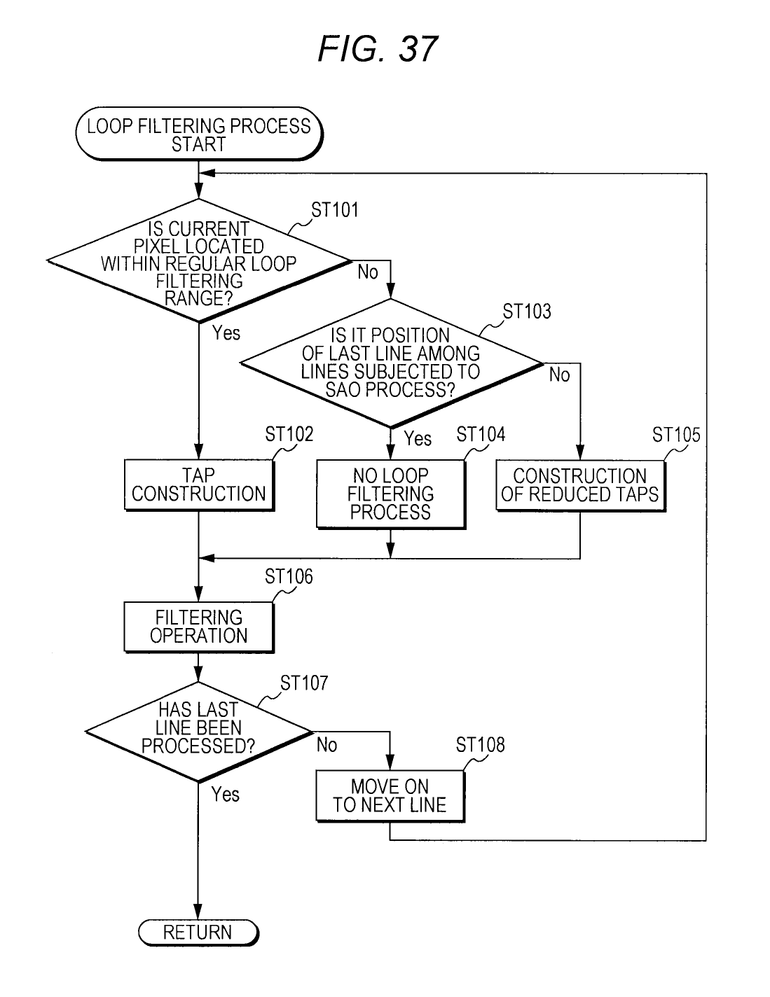

FIG. 37 is a flowchart showing a process in which the loop filtering process is not performed on a certain line when the number of taps is reduced. In step ST101, the loop filtering unit 25 determines whether the current pixel is located within a regular loop filtering range. The loop filtering unit 25 determines whether the line position of the current pixel being processed by the loop filter is such a position that pixels not subjected to the processing by the SAO unit 28 are not included as taps. If the line position is such a position that pixels not subjected to the processing by the SAO unit 28 are not included as taps, the loop filtering unit 25 determines that the line position is located within the regular loop filtering range, and moves on to step ST102. If the line position is such a position that pixels not subjected to the processing by the SAO unit 28 are included as taps, the loop filtering unit 25 determines that the line position is outside the regular loop filtering range, and moves on to step ST103.

In step ST102, the loop filtering unit 25 constructs taps. Since pixels not subjected to the processing by the SAO unit 28 are not included as taps, the loop filtering unit 25 sets a predetermined number of taps, such as 5×5 pixel taps, and then moves on to step ST106.

In step ST103, the loop filtering unit 25 determines whether the line position is positioned as the line subjected to the SAO process and is processed immediately before the SAO process is stopped (the position of the last line among the lines subjected to the SAO process). If the line position is the position of the last line among the lines subjected to the SAO process, the loop filtering unit 25 moves on to step ST104. If the line position has not reached the position of the last line among the lines subjected to the SAO process, the loop filtering unit 25 moves on to step ST105.

In step ST104, the loop filtering unit 25 performs setting so as not to perform the loop filtering process. For example, the loop filtering unit 25 sets such a filter coefficient as to output the image data of the pixel being subjected to the loop filtering process as it is, and then moves on to step ST106.

In step ST105, the loop filtering unit 25 constructs a reduced number of taps. The loop filtering unit 25 reduces the number of taps so that the pixels not subjected to the processing by the SAO unit 28 are not used as taps. For example, the number of taps is reduced to 3×3 pixels so that pixels not subjected to the processing by the SAO unit 28 are not used, and the operation then moves on to step ST106.

In step ST106, the loop filtering unit 25 performs a filtering operation. The loop filtering unit 25 performs the filtering operation by using the taps constructed by the processing in steps ST102 through ST105, and calculates the image data subjected to the loop filtering process for the current pixel.

In step ST107, the loop filtering unit 25 determines whether the last line has been processed. The loop filtering unit 25 determines whether the loop filtering process has been performed on the last line among the lines subjected to the SAO process in the LCU. If the process has not been performed on the last line, the loop filtering unit 25 moves on to step ST108. If the loop filtering process has been performed on the last line, the loop filtering unit 25 ends the processing of the LCU until a block in a lower stage is processed, and the next line is processed by the SAO unit 28.

In step ST108, the loop filtering unit 25 moves the line of the current pixel to the next line, and returns to step ST101.

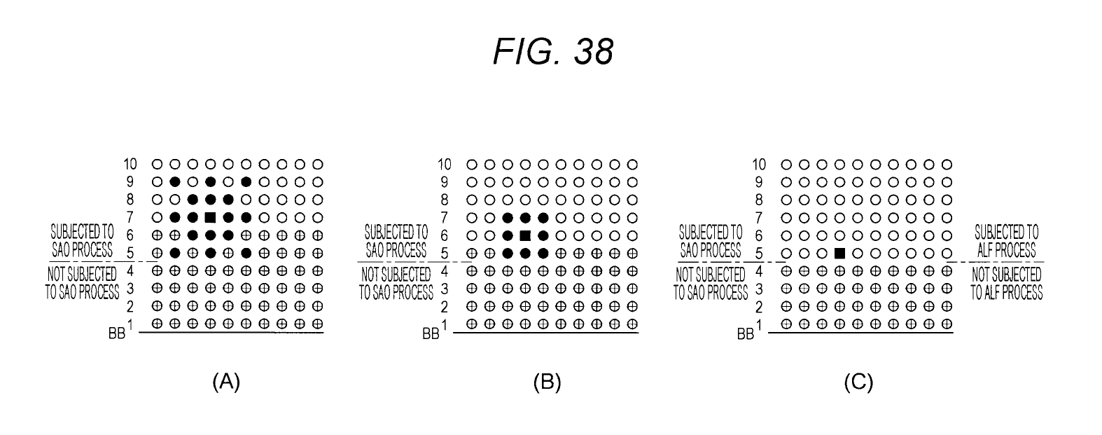

FIG. 38 illustrates an operation of the loop filtering unit 25 in a case where a line boundary of a range formed with several lines from a boundary of a largest coding unit as the largest unit among coding units is set as a boundary, or a case where the loop filtering process is not to be performed on the last line among the lines subjected to the SAO process, for example.

As shown in (A) of FIG. 38, the loop filtering unit 25 determines that the SAO process has not been performed on the first through fourth lines from the lower block boundary BB, and has been performed on the fifth line and the lines above the fifth line. Therefore, in a case where predetermined taps are taps of 5×5 pixels, the loop filtering unit 25 performs a loop filtering process on the first through seventh lines from the lower block boundary BB.

The loop filtering unit 25 then performs the loop filtering process on a predetermined number of taps in a position on the sixth line from the lower block boundary BB, and in doing so, requires pixels that have not been processed by the SAO unit 28 (pixels on the fourth line from the lower block boundary BB). Therefore, the loop filtering unit 25 reduces the number of taps so that the filtering process can be performed without the use of pixels that have not been processed by the SAO unit 28. For example, the number of taps is reduced to 3×3 pixels, as shown in (B) of FIG. 38. In this manner, the loop filtering process can proceed to a position on the sixth line from the lower block boundary BB.

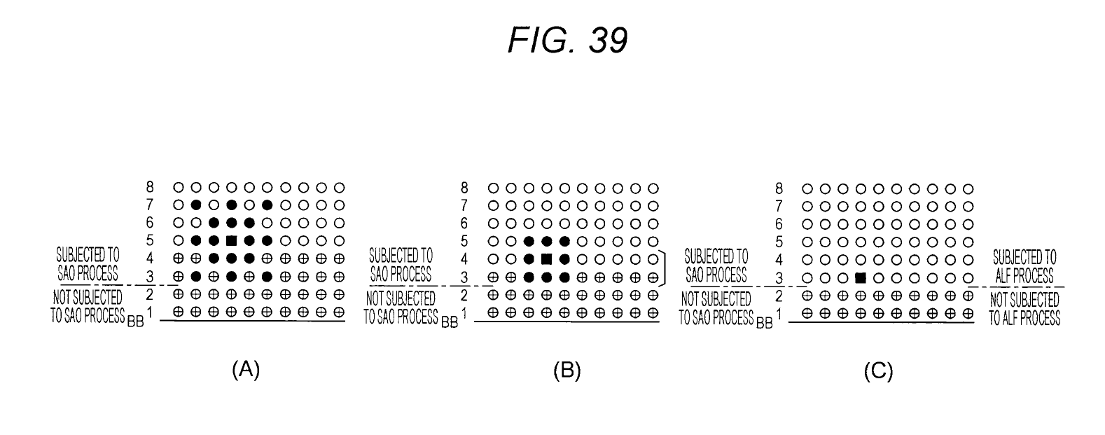

Further, the loop filtering unit 25 performs the loop filtering process on the reduced number of taps in a position on the fifth line from the lower block boundary BB or the position of the last line among the lines subjected to the SAO process, and in doing so, requires pixels that have not been processed by the SAO unit 28 (pixels on the fourth line from the lower block boundary BB). Therefore, the loop filtering unit 25 does not perform the loop filtering process for the current pixel. In this manner, the loop filtering process by the loop filtering unit 25 can proceed to a position on the fifth line from the lower block boundary BB. Also, there is no need to store the image data processed by the loop filtering unit 25, and accordingly, the line memory can be further reduced. FIG. 39 illustrates an operation of the loop filtering unit 25 for chrominance data. (A) of FIG. 39 shows a case where the number of taps is not reduced. (B) of FIG. 39 shows a case where the number of taps is reduced. (C) of FIG. 39 shows a case where the loop filtering process is not performed in the position of the last lines among the lines subjected to the SAO process.

In this specification, the terms “block” and “macroblock” refer to coding units (CU), prediction units (PU), and transform units (TU) in the context of HEVC.

The above described series of processes can be performed by hardware, software, or a combination of hardware and software. When operations are performed by software, a program in which the operation sequences are recorded is installed in a memory incorporated into specialized hardware in a computer. Alternatively, the operations can be performed by installing the program into a general-purpose computer that can perform various kinds of operations.

For example, the program can be recorded beforehand on a hard disk or a ROM (Read Only Memory) as a recording medium. Alternatively, the program can be temporarily or permanently stored (recorded) in a removable recording medium such as a flexible disk, a CD-ROM (Compact Disc Read Only Memory), a MO (Magneto Optical) disk, a DVD (Digital Versatile Disc), a magnetic disk, or a semiconductor memory. Such a removable recording medium can be provided as so-called packaged software.

The program can be not only installed into the computer from the above described removable recording medium, but also wirelessly transferred from a download site to the computer or transferred to the computer by wire via a network such as a LAN (Local Area Network) or the Internet. The program transferred in this manner can be received in the computer and be installed into a recording medium such as an internal hard disk.

### <15. Applications>

The image encoding device 10 and the image decoding device 50 according to the above described embodiments using image processing devices of the present technique can be applied to various electronic apparatuses including: transmitters and receivers for satellite broadcasting, cable broadcasting such as cable television, deliveries via the Internet, deliveries to terminals by cellular communications, and the like; recording apparatuses that record images on media such as optical disks, magnetic disks, or flash memories; or reproducing apparatuses that reproduce images from those storage media. Four examples of applications will be described below.

### [First Application]

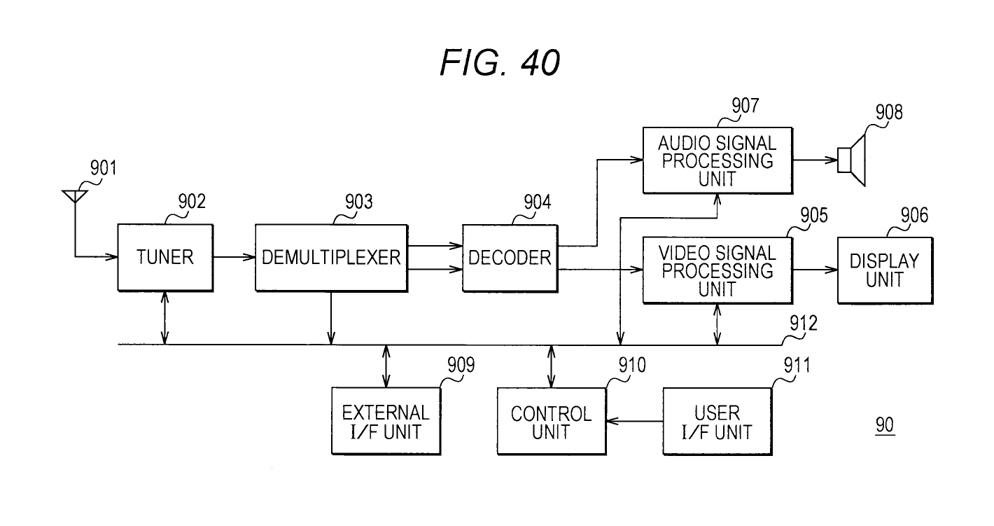

FIG. 40 schematically shows an example structure of a television apparatus to which the above described embodiments are applied. The television apparatus 90 includes an antenna 901, a tuner 902, a demultiplexer 903, a decoder 904, a video signal processing unit 905, a display unit 906, an audio signal processing unit 907, a speaker 908, and an external interface unit 909. The television apparatus 90 further includes a control unit 910, a user interface unit 911, and the like.

The tuner 902 extracts a signal of a desired channel from broadcast signals received via the antenna 901, and demodulates the extracted signal. The tuner 902 then outputs an encoded bit stream obtained by the demodulation to the demultiplexer 903. That is, the tuner 902 serves as transmitting means in the television apparatus 90 that receives an encoded stream of encoded images.

The demultiplexer 903 separates a video stream and an audio stream of a program to be viewed from the encoded bit stream, and outputs the separated streams to the decoder 904. The demultiplexer 903 also extracts auxiliary data such as an EPG (Electronic Program Guide) from the encoded bit stream, and supplies the extracted data to the control unit 910. If the encoded bit stream is scrambled, the demultiplexer 903 may descramble the encoded bit stream.

The decoder 904 decodes the video stream and the audio stream input from the demultiplexer 903. The decoder 904 then outputs video data generated by the decoding to the video signal processing unit 905. The decoder 904 also outputs audio data generated by the decoding to the audio signal processing unit 907.

The video signal processing unit 905 reproduces video data input from the decoder 904, and displays the video data on the display unit 906. The video signal processing unit 905 may also display an application screen supplied via the network on the display unit 906. Furthermore, the video signal processing unit 905 may perform additional processing such as denoising on the video data, depending on settings. The video signal processing unit 905 may further generate an image of a GUI (graphical user interface) such as a menu, a button, or a cursor, and superimpose the generated image on an output image.

The display unit 906 is driven by a drive signal supplied from the video signal processing unit 905, and displays a video image or an image on the video screen of a display device (such as a liquid crystal display, a plasma display, or an OELD).

The audio signal processing unit 907 performs reproduction processing such as a D/A conversion and amplification on the audio data input from the decoder 904, and outputs sound through the speaker 908. Also, the audio signal processing unit 907 may perform additional processing such as denoising on the audio data. The external interface unit 909 is an interface for connecting the television apparatus 90 to an external device or a network. For example, a video stream or an audio stream received via the external interface unit 909 may be decoded by the decoder 904. That is, the external interface unit 909 also serves as a transmission means in the television apparatus 90 that receives an encoded stream of encoded images.

The control unit 910 includes a processor such as a CPU (Central Processing Unit), and a memory such as a RAM (Random Access Memory) and a ROM (Read Only Memory). The memory stores programs to be executed by the CPU, program data, EPG data, data acquired via the network, and the like. The programs stored in the memory are read by the CPU at the time of activation of the television apparatus 90, for example, and are then executed. By executing the programs, the CPU controls operations of the television apparatus 90 in accordance with an operating signal input from the user interface unit 911, for example.

The user interface unit 911 is connected to the control unit 910. The user interface unit 911 includes buttons and switches for users to operate the television apparatus 90 and a reception unit for receiving remote control signals, for example. The user interface unit 911 detects a user operation via these components, generates an operating signal, and outputs the generated operating signal to the control unit 910.

The bus 912 connects the tuner 902, the demultiplexer 903, the decoder 904, the video signal processing unit 905, the audio signal processing unit 907, the external interface unit 909, and the control unit 910 to one another.

In the television apparatus 90 having such a structure, the decoder 904 has the functions of the image decoding device 50 according to the embodiments described above. Accordingly, the memory capacity of the line memory can be reduced when an image is decoded in the television apparatus 90.

### [Second Application]

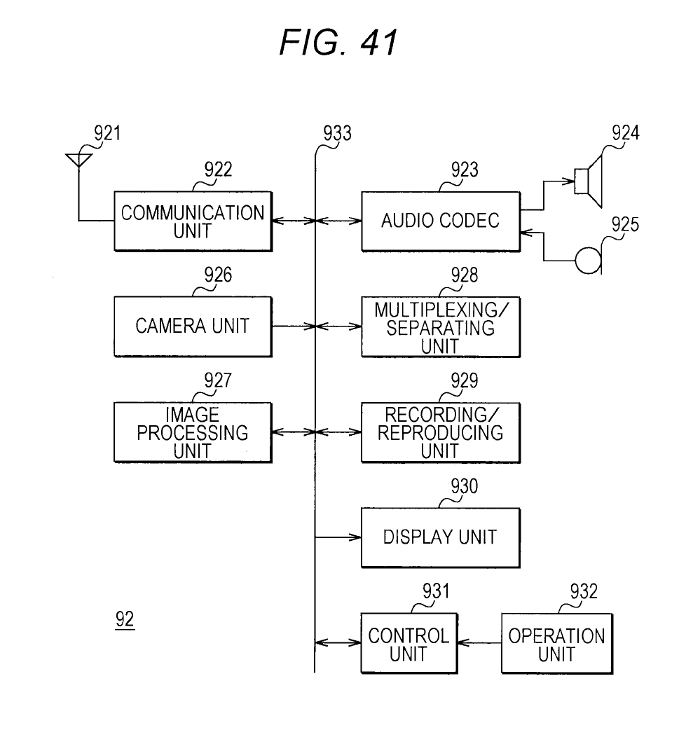

FIG. 41 schematically shows an example structure of a portable telephone device to which the above described embodiments are applied. The portable telephone device 92 includes an antenna 921, a communication unit 922, an audio codec 923, a speaker 924, a microphone 925, a camera unit 926, an image processing unit 927, a multiplexing/separating unit 928, a recording/reproducing unit 929, a display unit 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 connects the communication unit 922, the audio codec 923, the camera unit 926, the image processing unit 927, the multiplexing/separating unit 928, the recording/reproducing unit 929, the display unit 930, and the control unit 931 to one another.

The portable telephone device 92 performs operations such as transmission and reception of audio signals, transmission and reception of electronic mail or image data, imaging operations, and data recording in various operation modes including an audio communication mode, a data communication mode, an imaging mode, and a video phone mode.

In the audio communication mode, an analog audio signal generated by the microphone 925 is supplied to the audio codec 923. The audio codec 923 converts the analog audio signal to audio data, and performs compression and an A/D conversion on the converted audio data. The audio codec 923 outputs the compressed audio data to the communication unit 922. The communication unit 922 encodes and modulates the audio data, to generate a transmission signal. The communication unit 922 transmits the generated transmission signal to a base station (not shown) via the antenna 921. The communication unit 922 also performs amplification and a frequency conversion on a radio signal received via the antenna 921, and obtains a received signal. The communication unit 922 generates audio data by demodulating and decoding the received signal, and outputs the generated audio data to the audio codec 923. The audio codec 923 performs decompression and a D/A conversion on the audio data, to generate an analog audio signal. The audio codec 923 then outputs the generated audio signal to the speaker 924 to output sound.

In the data communication mode, the control unit 931 generates text data forming an electronic mail in accordance with an operation by the user via the operation unit 932. The control unit 931 also displays the text on the display unit 930. The control unit 931 also generates electronic mail data in accordance with a transmission instruction from the user via the operation unit 932, and outputs the generated electronic mail data to the communication unit 922. The communication unit 922 encodes and modulates the electronic mail data, to generate a transmission signal. The communication unit 922 transmits the generated transmission signal to a base station (not shown) via the antenna 921. The communication unit 922 also performs amplification and a frequency conversion on a radio signal received via the antenna 921, and obtains a received signal. The communication unit 922 then restores the electronic mail data by demodulating and decoding the received signal, and outputs the restored electronic mail data to the control unit 931. The control unit 931 displays the content of the electronic mail on the display unit 930, and stores the electronic mail data into a storage medium of the recording/reproducing unit 929.

The recording/reproducing unit 929 includes a readable/writable storage medium. For example, the storage medium may be an internal storage medium such as a RAM or a flash memory, or may be a storage medium of an externally mounted type such as a hard disk, a magnetic disk, a magneto optical disk, an optical disk, a USB memory, or a memory card.

In the imaging mode, the camera unit 926 generates image data by capturing an image of an object, and outputs the generated image data to the image processing unit 927. The image processing unit 927 encodes the image data input from the camera unit 926, and stores the encoded stream into the storage medium in the recording/reproducing unit 929.

In the video phone mode, the multiplexing/separating unit 928 multiplexes a video stream encoded by the image processing unit 927 and an audio stream input from the audio codec 923, and outputs the multiplexed stream to the communication unit 922. The communication unit 922 encodes and modulates the stream, to generate a transmission signal. The communication unit 922 transmits the generated transmission signal to a base station (not shown) via the antenna 921. The communication unit 922 also performs amplification and a frequency conversion on a radio signal received via the antenna 921, and obtains a received signal. The transmission signal and the received signal each include an encoded bit stream. The communication unit 922 restores a stream by demodulating and decoding the received signal, and outputs the restored stream to the multiplexing/separating unit 928. The multiplexing/separating unit 928 separates the video stream and the audio stream from the input stream, and outputs the video stream to the image processing unit 927 and the audio stream to the audio codec 923. The image processing unit 927 decodes the video stream, to generate video data. The video data is supplied to the display unit 930, and a series of images is displayed by the display unit 930. The audio codec 923 performs decompression and a D/A conversion on the audio stream, to generate an analog audio signal. The audio codec 923 then outputs the generated audio signal to the speaker 924 to output sound.

In the portable telephone device 92 having the above described structure, the image processing unit 927 has the functions of the image encoding device 10 and the image decoding device 50 according to the above described embodiments. Accordingly, the memory capacity of the line memory can be reduced when an image is encoded or decoded in the portable telephone device 92.

### [Third Application]

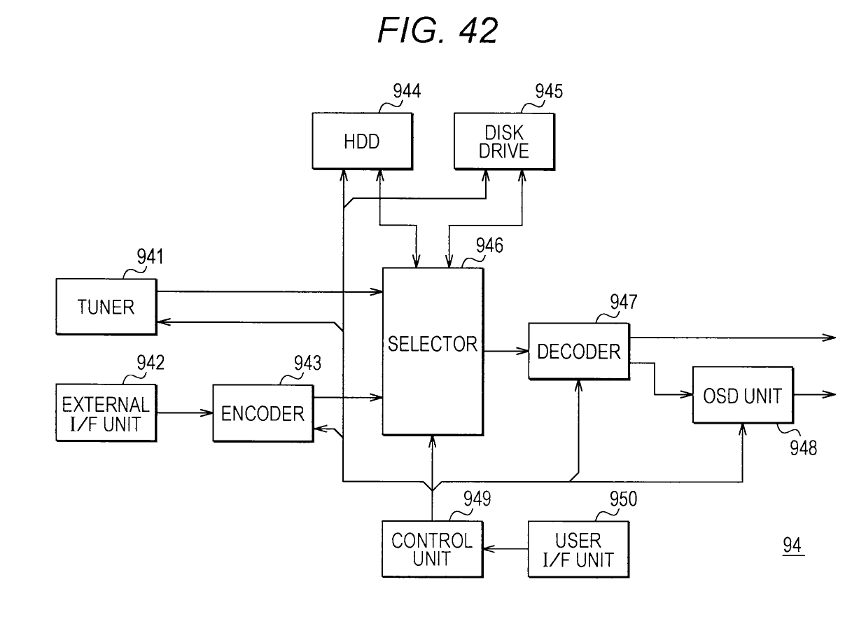

FIG. 42 schematically shows an example structure of a recording/reproducing apparatus to which the above described embodiments are applied. A recording/reproducing apparatus 94 encodes audio data and video data of a received broadcast show, for example, and records the audio data and the video data on a recording medium. The recording/reproducing apparatus 94 may encode audio data and video data acquired from another apparatus, for example, and record the audio data and the video data on the recording medium. The recording/reproducing apparatus 94 also reproduces data recorded on the recording medium through a monitor and a speaker in accordance with an instruction from the user, for example. In doing so, the recording/reproducing apparatus 94 decodes audio data and video data.

The recording/reproducing apparatus 94 includes a tuner 941, an external interface unit 942, an encoder 943, an HDD (Hard Disk Drive) 944, a disk drive 945, a selector 946, a decoder 947, an OSD (On-Screen Display) unit 948, a control unit 949, and a user interface unit 950.

The tuner 941 extracts a signal of a desired channel from broadcast signals received via an antenna (not shown), and demodulates the extracted signal. The tuner 941 then outputs the encoded bit stream obtained by the demodulation to the selector 946. That is, the tuner 941 serves as a transmission means in the recording/reproducing apparatus 94.

The external interface unit 942 is an interface for connecting the recording/reproducing apparatus 94 to an external device or a network. The external interface unit 942 may be an IEEE1394 interface, a network interface, a USB interface, or a flash memory interface, for example. Video data and audio data received via the external interface unit 942 are input to the encoder 943, for example. That is, the external interface unit 942 serves as a transmission means in the recording/reproducing apparatus 94.

In a case where video data and audio data input from the external interface unit 942 are not encoded, the encoder 943 encodes the video data and the audio data. The encoder 943 then outputs the encoded bit stream to the selector 946.

The HDD 944 records an encoded bit stream formed by compressing content data such as video images and sound, various programs, and other data on an internal hard disk. At the time of reproduction of video images and sound, the HDD 944 reads those data from the hard disk.

The disk drive 945 records data on and reads data from a recording medium mounted thereon. The recording medium mounted on the disk drive 945 may be a DVD (such as a DVD-Video, a DVD-RAM, a DVD-R, a DVD-RW, a DVD+R, or a DVD+RW) or a Blu-ray (a registered trade name) disc, for example.

At the time of recording of video images and sound, the selector 946 selects an encoded bit stream input from the tuner 941 or the encoder 943, and outputs the selected encoded bit stream to the HDD 944 or the disk drive 945. At the time of reproduction of video images and sound, the selector 946 also outputs an encoded bit stream input from the HDD 944 or the disk drive 945, to the decoder 947.

The decoder 947 decodes the encoded bit stream, and generates video data and audio data. The decoder 947 outputs the generated video data to the OSD unit 948. The decoder 904 also outputs the generated audio data to an external speaker.

The OSD unit 948 reproduces the video data input from the decoder 947, and displays a video image. The OSD unit 948 may superimpose an image of a GUI such as a menu, a button, or a cursor on the video image to be displayed.

The control unit 949 includes a processor such as a CPU, and a memory such as a RAM and a ROM. The memory stores programs to be executed by the CPU, program data, and the like. The programs stored in the memory are read by the CPU at the time of activation of the recording/reproducing apparatus 94, for example, and are then executed. By executing the programs, the CPU controls operations of the recording/reproducing apparatus 94 in accordance with an operating signal input from the user interface unit 950, for example.

The user interface unit 950 is connected to the control unit 949. The user interface unit 950 includes buttons and switches for the user to operate the recording/reproducing apparatus 94, and a reception unit for remote control signals, for example. The user interface unit 950 generates an operating signal by detecting an operation by the user via those components, and outputs the generated operating signal to the control unit 949.

In the recording/reproducing apparatus 94 having the above described structure, the encoder 943 has the functions of the image encoding device 10 according to the above described embodiments. Furthermore, the decoder 947 has the functions of the image decoding device 50 according to the above described embodiments. Accordingly, the memory capacity of the line memory can be reduced when an image is encoded or decoded in the recording/reproducing apparatus 94.

### [Fourth Application]

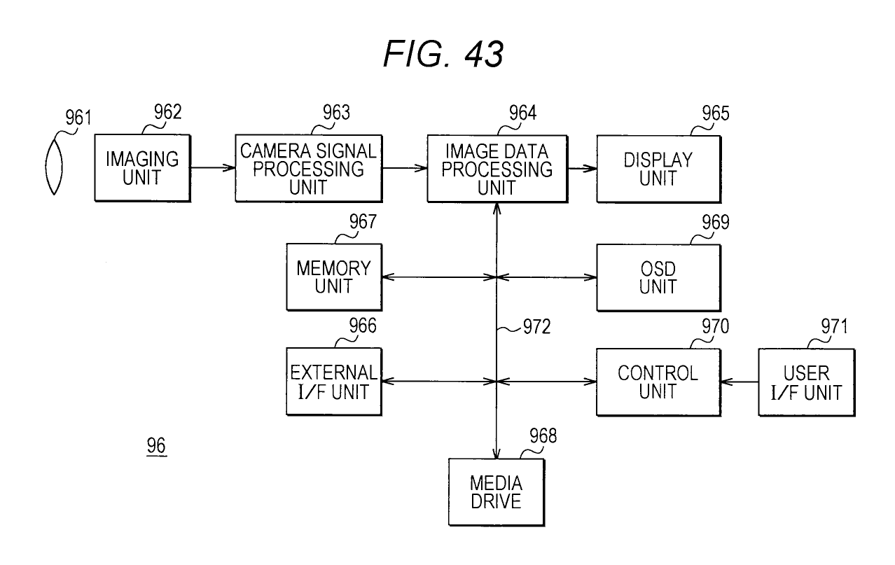

FIG. 43 schematically shows an example structure of an imaging apparatus to which the above described embodiments are applied. An imaging apparatus 96 generates images by imaging an object, encodes the image data, and records the image data on a recording medium.

The imaging apparatus 96 includes an optical block 961, an imaging unit 962, a camera signal processing unit 963, an image processing unit 964, a display unit 965, an external interface unit 966, a memory 967, a media drive 968, an OSD unit 969, a control unit 970, a user interface unit 971, and a bus 972.

The optical block 961 includes a focus lens, a diaphragm, and the like. The optical block 961 forms an optical image of an object on the imaging surface of the imaging unit 962. The imaging unit 962 includes an image sensor such as a CCD or a CMOS, and converts the optical image formed on the imaging surface into an image signal as an electrical signal through a photoelectric conversion. The imaging unit 962 outputs the image signal to the camera signal processing unit 963.

The camera signal processing unit 963 performs various kinds of camera signal processing such as knee correction, gamma correction, and color correction on the image signal input from the imaging unit 962. The camera signal processing unit 963 outputs the image data subjected to the camera signal processing to the image processing unit 964.

The image processing unit 964 encodes the image data input from the camera signal processing unit 963, and generates encoded data. The image processing unit 964 outputs the generated encoded data to the external interface unit 966 or the media drive 968. The image processing unit 964 also decodes encoded data input from the external interface unit 966 or the media drive 968, and generates image data. The image processing unit 964 then outputs the generated image data to the display unit 965. Alternatively, the image processing unit 964 may output the image data input from the camera signal processing unit 963 to the display unit 965 to display an image. The image processing unit 964 may also superimpose display data acquired from the OSD unit 969 on the image to be output to the display unit 965.

The OSD unit 969 generates an image of a GUI such as a menu, a button, or a cursor, and outputs the generated image to the image processing unit 964.

The external interface unit 966 is formed as a USB input/output terminal, for example. The external interface unit 966 connects the imaging apparatus 96 to a printer at the time of printing of an image, for example. A drive is also connected to the external interface unit 966, if necessary. A removable medium such as a magnetic disk or an optical disk is mounted on the drive so that a program read from the removable medium can be installed into the imaging apparatus 96. Further, the external interface unit 966 may be designed as a network interface to be connected to a network such as a LAN or the Internet. That is, the external interface unit 966 serves as a transmission means in the imaging apparatus 96.

A recording medium to be mounted on the media drive 968 may be a readable/rewritable removable medium such as a magnetic disk, a magneto optical disk, an optical disk, or a semiconductor memory. Also, a recording medium may be fixed to the media drive 968, to form a non-portable storage unit such as an internal hard disk drive or an SSD (Solid State Drive).

The control unit 970 includes a processor such as a CPU, and a memory such as a RAM and a ROM. The memory stores programs to be executed by the CPU, program data, and the like. The programs stored in the memory are read by the CPU at the time of activation of the imaging apparatus 96, for example, and are then executed. By executing the programs, the CPU controls operations of the imaging apparatus 96 in accordance with an operating signal input from the user interface unit 971, for example.

The user interface unit 971 is connected to the control unit 970. The user interface unit 971 includes buttons and switches for the user to operate the imaging apparatus 96, for example. The user interface unit 971 generates an operating signal by detecting an operation by the user via those components, and outputs the generated operating signal to the control unit 970.

The bus 972 connects the image processing unit 964, the external interface unit 966, the memory 967, the media drive 968, the OSD unit 969, and the control unit 970 to one another.

In the imaging apparatus 96 having the above described structure, the image processing unit 964 has the functions of the image encoding device 10 and the image decoding device 50 according to the above described embodiments. Accordingly, the memory capacity of the line memory can be reduced when an image is encoded or decoded in the imaging apparatus 96.

Further, the present technique should not be interpreted to be limited to the above described embodiments. The embodiments disclose the present technique in the form of examples, and it is apparent that a person skilled in the art can make changes or modifications to the embodiments without departing from the scope of the present technique. That is, the claims should be taken into account in understanding the subject matter of the technique.

Image processing devices according to the present technique can also have the following structures.

(1) An image processing device including:

a decoding unit that generates an image by decoding encoded data generated by encoding an image;

a filtering operation unit that performs a filtering operation by using image data and a coefficient set of a tap constructed with respect to a pixel to be filtered, the pixel to be filtered being of the image generated by the decoding unit; and

a filter control unit that controls the filtering operation to be performed without use of image data within a predetermined range from a boundary when the position of the tap is located within the predetermined range.

(2) The image processing device of (1), wherein the filter control unit replaces the image data of the tap located within the predetermined range or changes the coefficient set.

(3) The image processing device of (2), wherein the filter control unit changes the shape of the tap of the filter so that the filtering operation is performed without the use of image data within the predetermined range.

(4) The image processing device of (2), wherein the filter control unit replaces the image data of the tap located in a region including a line located outside the boundary or changes the coefficient set of the filter, when an upper end or a lower end of the filter is located outside the boundary.

(5) The image processing device of (2), wherein the filter control unit changes the tap size or the tap shape of the filter so that the pixels of the lines located outside the boundary are not used, when an upper end or a lower end of the filter is located outside the line boundary.

(6) The image processing device of (2), wherein the filter control unit replaces the image data or changes the coefficient set so that a pixel adjacent to the outer periphery of a boundary of the predetermined range is copied in the vertical direction and is used as a tap in the predetermined range.

(7) The image processing device of (2), wherein the filter control unit replaces the image data or changes the coefficient set so that the position of a pixel adjacent to the outer periphery of a boundary of the predetermined range is set as the axis of mirror copying, and the pixel having a mirror copy thereof formed on a tap located within the predetermined range is used.

(8) The image processing device of (2), wherein the filtering operation unit performs the filtering operation by using a coefficient set constructed based on coefficient set information included in the encoded image.

(9) The image processing device of any of (2) through (8), wherein the predetermined range is the filtering range of a deblocking filtering process.

(10) The image processing device of any of (2) through (9), wherein the predetermined range is a pixel range in which an SAO (Sample Adaptive Offset) process has not been performed.

(11) The image processing device of any of (2) through (10), wherein

the encoded data is encoded for each coding unit having a hierarchical structure, and

the boundary is a boundary of a largest coding unit as the largest unit among coding units.

(12) The image processing device of any of (2) through (11), wherein the boundary is a boundary of the predetermined range.

(13) The image processing device of any of (2) through (12), wherein

the encoded data is encoded for each coding unit having a hierarchical structure, and

the boundary is a line boundary that is a boundary of a range including lines counted from a boundary of a largest coding unit as the largest unit among coding units.

### INDUSTRIAL APPLICABILITY

In an image processing device and an image processing method of this technique, a filtering operation is performed by using the image data and the coefficient set of taps constructed for the pixel being subjected to a filtering process for an image generated by decoding encoded data generated by encoding an image. When tap positions are located within a predetermined range from a boundary, the filtering operation is controlled to be performed without the use of image data within the predetermined range. Accordingly, an adaptive loop filtering process can be performed without the use of image data subjected to a deblocking filtering process, for example, and the memory capacity of the line memory used in the loop filtering process can be reduced. Thus, electronic devices to which an image processing device and an image processing method of this technique are applied can be provided at reasonable prices.

### REFERENCE SIGNS LIST

10 Image encoding device, 11 A/D converter, 12, 58 Screen rearrangement buffer, 13 Subtraction unit, 14 Orthogonal transform unit, 15 Quantization unit, 16 Lossless encoding unit, 17 Accumulation buffer, 18 Rate control unit, 21, 53 Inverse quantization unit, 22, 54 Inverse orthogonal transform unit, 23, 55 Addition unit, 24, 56 Deblocking filtering unit, 25, 57 Loop filtering unit, 26 Coefficient memory unit, 27, 61 Frame memory, 28, 60 SAO (Sample Adaptive Offset) unit, 29, 62, 65 Selector, 31, 63 Intra prediction unit, 32 Motion prediction/compensation unit, 33 Predicted image/optimum mode selection unit, 50 Image decoding device, 51 Accumulation buffer, 52 Lossless decoding unit, 59 D/A converter, 64 Motion compensation unit, 90 Television apparatus, 92 Portable telephone device, 94 Recording/reproducing apparatus, 96 Imaging apparatus, 251 Line memory, 252 Tap construction unit, 253 Coefficient construction unit, 254 Filtering operation unit, 255 Center tap output unit, 256 Output selection unit, 259 Filter control unit

1. An image processing device comprising:
a decoding unit configured to generate an image by decoding encoded data generated by encoding an image;
a filtering operation unit configured to perform a filtering operation by using image data and a coefficient set of a tap constructed with respect to a pixel to be filtered, the pixel to be filtered being of the image generated by the decoding unit; and
a filter control unit configured to control the filtering operation to be performed without use of image data within a predetermined range from a boundary when a position of the tap is located within the predetermined range.

2. The image processing device according to claim 1, wherein the filter control unit replaces the image data of the tap located within the predetermined range or changes the coefficient set.

3. The image processing device according to claim 2, wherein the filter control unit changes shape of the tap of the filter so that the filtering operation is performed without use of image data within the predetermined range.

4. The image processing device according to claim 2, wherein the filter control unit replaces the image data of the tap located in a region including a line located outside the boundary or changes the coefficient set of the filter, when an upper end or a lower end of the filter is located outside the boundary.

5. The image processing device according to claim 2, wherein the filter control unit changes a tap size or a tap shape of the filter so that pixels of lines located outside the boundary are not used, when an upper end or a lower end of the filter is located outside the line boundary.

6. The image processing device according to claim 2, wherein the filter control unit replaces the image data or changes the coefficient set so that a pixel adjacent to an outer periphery of a boundary of the predetermined range is copied in a vertical direction and is used as a tap in the predetermined range.

7. The image processing device according to claim 2, wherein the filter control unit replaces the image data or changes the coefficient set so that a position of a pixel adjacent to an outer periphery of a boundary of the predetermined range is set as an axis of mirror copying, and the pixel having a mirror copy thereof formed on a tap located within the predetermined range is used.

8. The image processing device according to claim 2, wherein the filtering operation unit performs the filtering operation by using a coefficient set constructed based on coefficient set information included in the encoded image.

9. The image processing device according to claim 2, wherein the predetermined range is a filtering range of a deblocking filtering process.

10. The image processing device according to claim 2, wherein the predetermined range is a pixel range in which an SAO (Sample Adaptive Offset) process has not been performed.

11. The image processing device according to claim 2, wherein
the encoded data is encoded for each coding unit having a hierarchical structure, and
the boundary is a boundary of a largest coding unit as the largest unit among coding units.

12. The image processing device according to claim 2, wherein the boundary is a boundary of the predetermined range.

13. The image processing device according to claim 2, wherein
the encoded data is encoded for each coding unit having a hierarchical structure, and
the boundary is a line boundary that is a boundary of a range of a plurality of lines counted from a boundary of a largest coding unit as the largest unit among coding units.

14. An image processing method comprising:
a step of generating an image by decoding encoded data generated by encoding an image;
a step of performing a filtering operation by using image data and a coefficient set of a tap constructed with respect to a pixel to be filtered, the pixel to be filtered being of the image generated by the decoding; and
a step of controlling the filtering operation to be performed without use of image data within a predetermined range from a boundary when a position of the tap is located within the predetermined range.

15. An image processing device comprising:
a filtering operation unit configured to perform a filtering operation by using image data and a coefficient set of a tap constructed with respect to a pixel to be filtered when an image is encoded, the pixel to be filtered being of the image subjected to local decoding;
a filter control unit configured to control the filtering operation to be performed without use of image data within a predetermined range from a boundary when a position of the tap is located within the predetermined range; and
an encoding unit configured to encode the image by using the image subjected to the filtering operation by the filtering operation unit.

16. The image processing device according claim 15, wherein the filter control unit replaces the image data of the tap located within the predetermined range or changes the coefficient set.

17. The image processing device according to claim 15, wherein the filter control unit changes shape of the tap of the filter so that the filtering operation is performed without use of image data within the predetermined range.

18. The image processing device according to claim 15, wherein the filter control unit replaces the image data of the tap located in a region including a line located outside the boundary or changes the coefficient set of the filter, when an upper end or a lower end of the filter is located outside the boundary.

19. An image processing method comprising:
a step of performing a filtering operation by using image data and a coefficient set of a tap constructed with respect to a pixel to be filtered when an image is encoded, the pixel to be filtered being of the image subjected to local decoding;
a step of controlling the filtering operation to be performed without use of image data within a predetermined range from a boundary when a position of the tap is located within the predetermined range; and
a step of encoding the image by using the image subjected to the filtering operation.
